(19) United States
(12) Patent Application Publication
(10) Pub. No.: US 2026/0222975 A1
(43) Pub. Date: Jul. 30, 2026

(54) DEVICE AND METHOD FOR PERFORMING DISCONTINUOUS PATH SELECTION-BASED QUANTUM RESOURCE ALLOCATION IN QUANTUM COMMUNICATION SYSTEM

(71) Applicant: LG ELECTRONICS INC., Seoul (KR)

(72) Inventors: Jayeong KIM, Seoul (KR); Hojae LEE, Seoul (KR); Byungkyu AHN, Seoul (KR); Sangrim LEE, Seoul (KR)

(73) Assignee: LG ELECTRONICS INC., Seoul (KR)

(21) Appl. No.: 19/147,661

(22) PCT Filed: Jan. 12, 2023
(86) PCT No.: PCT/KR2023/000547

§ 371 Date: Jul. 11, 2025

(51) Int. Cl. H04W 48/16; H04L 45/02; H04L 47/52; H04W 48/18

(52) U.S. Cl. CPC H04W 48/16; H04L 45/02; H04L 47/527; H04W 48/18

(57) ABSTRACT

According to various embodiments of the present disclosure, there is provided a method of operating a third node in a communication system. The method includes transmitting one or more synchronization signals to multiple nodes, transmitting system information to the multiple nodes, receiving a random access preamble from the multiple nodes, transmitting a random access response to the multiple nodes, receiving network topology information from the multiple nodes, the network topology information including information on an entanglement distribution success rate of multiple links related to the multiple nodes, and information on a bell state measurement (BSM) success rate of the multiple nodes, receiving, from a first node among the multiple nodes, a quantum resource allocation (QRA) request message for a data transmission to a second node among the multiple nodes, acquiring information on multiple optimal paths between the first node and the second node, the multiple optimal paths being determined based on the network topology information, generating timing information related to the multiple optimal paths, and transmitting a QRA command message including the timing information.

### TECHNICAL FIELD

The present disclosure relates to a device and method for allocating entanglement resources for quantum data transmission between a source node and a destination node connected through multiple hops in a quantum communication system. Specifically, the present disclosure relates to a device and method for improving a quantum resource allocation rate by selecting multiple optimal paths connecting a source node and a destination node and allocating entanglement resources through the multiple optimal paths, considering network resource efficiency, fairness of network resource utilization between nodes, quality of service (QoS) requirements, etc., based on network topology information including information, such as an entanglement distribution success rate of each direct quantum channel link and a Bell state measurement (BSM) success rate of each node, in a quantum communication system.

### BACKGROUND ART

In the future, long-distance transmission of quantum information through quantum networks will emerge as an important research field. The need for multi-hop quantum teleportation research is emerging to transmit quantum information between two distant nodes. A quantum channel may be constructed through entanglement shared by two contiguous nodes, and intermediate nodes, such as repeaters or trusted nodes, are introduced to transmit quantum information between nodes that do not directly share entanglement.

In such a quantum network environment, since a direct quantum channel through which entanglement can be shared through direct transmission is not formed between any source node and destination node, technologies for multi-hop quantum information transmission are required. There are two major approaches to studies related to such multi-hop quantum information transmission. The first approach is a multi-hop quantum teleportation scheme that performs quantum teleportation on a hop-by-hop basis, similar to routing in classical communication so that information is transmitted to the destination node through hop-by-hop transmission. Another approach is a multi-hop entanglement swapping scheme that first forms entanglement to be used for information transmission between a source node and a destination node by performing multiple entanglement swappings on multi-hop links, and then performs quantum teleportation using the entanglement so that actual data can be transmitted to the destination node without directly traveling all multi-hop paths.

In order to perform multi-hop quantum teleportation or multi-hop entanglement swapping, an algorithm is needed to find a shortest path with a highest success rate among multiple multi-hop paths connecting a source node and a destination node. If routing in classical communication used an algorithm that finds a shortest path from a perspective of minimizing a transmission delay by considering a bandwidth of each link and a distance to a destination node because data transmission through a multi-hop path is performed hop by hop, multi-hop quantum teleportation or multi-hop entanglement swapping in quantum networks simultaneously involves quantum channel transmission or Bell state measurement, or the like at each hop constituting a multi-hop path. Therefore, for successful transmission, there is no transmission delay based on a length of the path or the number of hops. However, when any multi-hop path is selected, the success of the quantum teleportation or entanglement swapping process for the entire path is characterized in being determined probabilistically based on a success rate of the entanglement distribution and Bell state measurement performed at each hop. Therefore, a shortest path algorithm and a quantum resource allocation rate enhancement scheme are required from a perspective of maximizing the success rate of the quantum teleportation or entanglement swapping process for the entire path by considering the characteristics described above.

### DISCLOSURE

### Technical Problem

In order to solve the above-described problems, the present disclosure provides a device and method for allocating entanglement resources for quantum data transmission between a source node and a destination node connected through multiple hops in a quantum communication system.

The present disclosure provides a device and method for improving a quantum resource allocation rate by selecting multiple optimal paths connecting a source node and a destination node and allocating entanglement resources through the multiple optimal paths, considering network resource efficiency, fairness of network resource utilization between nodes, quality of service (QoS) requirements, etc., based on network topology information including information, such as an entanglement distribution success rate of each direct quantum channel link and a Bell state measurement (BSM) success rate of each node, in a quantum communication system.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

According to various embodiments of the present disclosure, there is provided a method of operating a third node in a communication system, the method comprising transmitting one or more synchronization signals to multiple nodes, transmitting system information to the multiple nodes, receiving a random access preamble from the multiple nodes, transmitting a random access response to the multiple nodes, receiving network topology information from the multiple nodes, the network topology information including information on an entanglement distribution success rate of multiple links related to the multiple nodes, and information on a bell state measurement (BSM) success rate of the multiple nodes, receiving, from a first node among the multiple nodes, a quantum resource allocation (QRA) request message for a data transmission to a second node among the multiple nodes, acquiring information on multiple optimal paths between the first node and the second node, the multiple optimal paths being determined based on the network topology information, generating timing information related to the multiple optimal paths, and transmitting a QRA command message including the timing information.

According to various embodiments of the present disclosure, there is provided a method of operating a third node in a communication system, the method comprising transmitting one or more synchronization signals to multiple nodes, transmitting system information to the multiple nodes, receiving a random access preamble from the multiple nodes, transmitting a random access response to the multiple nodes, broadcasting and receiving, from a first node among the multiple nodes, a quantum resource allocation (QRA) request message for a data transmission to a second node among the multiple nodes, wherein the first node shares network topology information with remaining nodes among the multiple nodes, and the network topology information includes information on an entanglement distribution success rate of multiple links related to the multiple nodes, and information on a bell state measurement (BSM) success rate of the multiple nodes, receiving a QRA response message including information on multiple optimal paths between the first node and the second node from one or more nodes included in the multiple optimal paths among the multiple nodes, generating timing information related to the multiple optimal paths, and transmitting a QRA command message including the timing information.

According to various embodiments of the present disclosure, there is provided a third node in a communication system, the third node comprising a transceiver and at least one processor, wherein the at least one processor is configured to transmit one or more synchronization signals to multiple nodes, transmit system information to the multiple nodes, receive a random access preamble from the multiple nodes, transmit a random access response to the multiple nodes, receive network topology information from the multiple nodes, the network topology information including information on an entanglement distribution success rate of multiple links related to the multiple nodes, and information on a bell state measurement (BSM) success rate of the multiple nodes, receive, from a first node among the multiple nodes, a quantum resource allocation (QRA) request message for a data transmission to a second node among the multiple nodes, acquire information on multiple optimal paths between the first node and the second node, the multiple optimal paths being determined based on the network topology information, generate timing information related to the multiple optimal paths, and transmit a QRA command message including the timing information.

According to various embodiments of the present disclosure, there is provided a third node in a communication system, the third node comprising a transceiver and at least one processor, wherein the at least one processor is configured to transmit one or more synchronization signals to multiple nodes, transmit system information to the multiple nodes, receive a random access preamble from the multiple nodes, transmit a random access response to the multiple nodes, broadcast and receive, from a first node among the multiple nodes, a quantum resource allocation (QRA) request message for a data transmission to a second node among the multiple nodes, wherein the first node shares network topology information with remaining nodes among the multiple nodes, and the network topology information includes information on an entanglement distribution success rate of multiple links related to the multiple nodes, and information on a bell state measurement (BSM) success rate of the multiple nodes, receive a QRA response message including information on multiple optimal paths between the first node and the second node from one or more nodes included in the multiple optimal paths among the multiple nodes, generate timing information related to the multiple optimal paths, and transmit a QRA command message including the timing information.

According to various embodiments of the present disclosure, there is provided a control device controlling a third node in a communication system, the control device comprising at least one processor and at least one memory operably connected to the at least one processor, wherein the at least one memory stores instructions performing operations based on being executed by the at least one processor, wherein the operations comprise transmitting one or more synchronization signals to multiple nodes, transmitting system information to the multiple nodes, receiving a random access preamble from the multiple nodes, transmitting a random access response to the multiple nodes, receiving network topology information from the multiple nodes, the network topology information including information on an entanglement distribution success rate of multiple links related to the multiple nodes, and information on a bell state measurement (BSM) success rate of the multiple nodes, receiving, from a first node among the multiple nodes, a quantum resource allocation (QRA) request message for a data transmission to a second node among the multiple nodes, acquiring information on multiple optimal paths between the first node and the second node, the multiple optimal paths being determined based on the network topology information, generating timing information related to the multiple optimal paths, and transmitting a QRA command message including the timing information.

According to various embodiments of the present disclosure, there is provided a control device controlling a third node in a communication system, the control device comprising at least one processor and at least one memory operably connected to the at least one processor, wherein the at least one memory stores instructions performing operations based on being executed by the at least one processor, wherein the operations comprise transmitting one or more synchronization signals to multiple nodes, transmitting system information to the multiple nodes, receiving a random access preamble from the multiple nodes, transmitting a random access response to the multiple nodes, broadcasting and receiving, from a first node among the multiple nodes, a quantum resource allocation (QRA) request message for a data transmission to a second node among the multiple nodes, wherein the first node shares network topology information with remaining nodes among the multiple nodes, and the network topology information includes information on an entanglement distribution success rate of multiple links related to the multiple nodes, and information on a bell state measurement (BSM) success rate of the multiple nodes, receiving a QRA response message including information on multiple optimal paths between the first node and the second node from one or more nodes included in the multiple optimal paths among the multiple nodes, generating timing information related to the multiple optimal paths, and transmitting a QRA command message including the timing information.

According to various embodiments of the present disclosure, there are provided one or more non-transitory computer readable mediums storing one or more instructions, wherein the one or more instructions perform operations based on being executed by one or more processors, wherein the operations comprise transmitting one or more synchronization signals to multiple nodes, transmitting system information to the multiple nodes, receiving a random access preamble from the multiple nodes, transmitting a random access response to the multiple nodes, receiving network topology information from the multiple nodes, the network topology information including information on an entanglement distribution success rate of multiple links related to the multiple nodes, and information on a bell state measurement (BSM) success rate of the multiple nodes, receiving, from a first node among the multiple nodes, a quantum resource allocation (QRA) request message for a data transmission to a second node among the multiple nodes, acquiring information on multiple optimal paths between the first node and the second node, the multiple optimal paths being determined based on the network topology information, generating timing information related to the multiple optimal paths, and transmitting a QRA command message including the timing information.

According to various embodiments of the present disclosure, there are provided one or more non-transitory computer readable mediums storing one or more instructions, wherein the one or more instructions perform operations based on being executed by one or more processors, wherein the operations comprise transmitting one or more synchronization signals to multiple nodes, transmitting system information to the multiple nodes, receiving a random access preamble from the multiple nodes, transmitting a random access response to the multiple nodes, broadcasting and receiving, from a first node among the multiple nodes, a quantum resource allocation (QRA) request message for a data transmission to a second node among the multiple nodes, wherein the first node shares network topology information with remaining nodes among the multiple nodes, and the network topology information includes information on an entanglement distribution success rate of multiple links related to the multiple nodes, and information on a bell state measurement (BSM) success rate of the multiple nodes, receiving a QRA response message including information on multiple optimal paths between the first node and the second node from one or more nodes included in the multiple optimal paths among the multiple nodes, generating timing information related to the multiple optimal paths, and transmitting a QRA command message including the timing information.

### Advantageous Effects

In order to solve the above-described problems, the present disclosure can provide a device and method for allocating entanglement resources for quantum data transmission between a source node and a destination node connected through multiple hops in a quantum communication system.

The present disclosure can provide a device and method for improving a quantum resource allocation rate by selecting multiple optimal paths connecting a source node and a destination node and allocating entanglement resources through the multiple optimal paths, considering network resource efficiency, fairness of network resource utilization between nodes, quality of service (QoS) requirements, etc., based on network topology information including information, such as an entanglement distribution success rate of each direct quantum channel link and a Bell state measurement (BSM) success rate of each node, in a quantum communication system.

### DESCRIPTION OF DRAWINGS

The accompanying drawings, which are included to provide a further understanding of the present disclosure and constitute a part of the detailed description, illustrate embodiments of the present disclosure and serve to explain technical features of the present disclosure together with the description. Technical features of the present disclosure are not limited to specific drawings, and features disclosed in each drawing can be combined with each other to form a new embodiment. Reference numerals in each drawing may denote structural elements.

FIG. 1 illustrates an example of physical channels and general signal transmission used for the 3GPP system.

FIG. 2 illustrates system architecture of new generation radio access network (NG-RAN).

FIG. 3 illustrates functional split between NG-RAN and 5GC.

FIG. 4 illustrates an example of 5G usage scenario.

FIG. 5 illustrates an example of a communication structure providable in a 6G system.

FIG. 6 schematically illustrates an example of a structure of a perceptron.

FIG. 7 schematically illustrates an example of a structure of a multilayer perceptron.

FIG. 8 schematically illustrates an example of a deep neural network.

FIG. 9 schematically illustrates an example of a convolutional neural network.

FIG. 10 schematically illustrates an example of a filter operation of a convolutional neural network.

FIG. 11 schematically illustrates an example of a neural network structure in which a circular loop exists.

FIG. 12 schematically illustrates an example of an operation structure of a recurrent neural network.

FIG. 13 illustrates an example of an electromagnetic spectrum.

FIG. 14 illustrates an example of THz communication application.

FIG. 15 illustrates an example of an electronic device-based THz wireless communication transceiver.

FIG. 16 illustrates an example of a method of generating an optical device-based THz signal.

FIG. 17 illustrates an example of an optical device-based THz wireless communication transceiver.

FIG. 18 illustrates a structure of a photonic source-based transmitter.

FIG. 19 illustrates a structure of an optical modulator.

FIG. 20 illustrates an example of a quantum circuit for generating a Bell state in a system applicable to the present disclosure.

FIG. 21 illustrates an example of a Bell state measurement circuit in a system applicable to the present disclosure.

FIG. 22 illustrates an example of a quantum teleportation system in a system applicable to the present disclosure.

FIG. 23 illustrates an example of spontaneous parametric down-conversion in a system applicable to the present disclosure.

FIG. 24 illustrates an example of an atom excitation method in an optical cavity using laser pulses in a system applicable to the present disclosure.

FIG. 25 illustrates an example of a simultaneous excitation method of two atoms using laser pulses in a system applicable to the present disclosure.

FIG. 26 illustrates an example of imperfection degrading a quantum teleportation process in a system applicable to the present disclosure.

FIG. 27 illustrates an example of a quantum channel model in a system applicable to the present disclosure.

FIG. 28 illustrates an example of Pauli-I, Pauli-Z, Pauli-X, and Pauli-Y gates in a system applicable to the present disclosure.

FIG. 29 illustrates an example of an error correction circuit for a 3-qubit bit flip code in a system applicable to the present disclosure.

FIG. 30 illustrates an example of an error correction circuit for a 3-qubit phase flip code in a system applicable to the present disclosure.

FIG. 31 illustrates an example of a Shor code error correction circuit in a system applicable to the present disclosure.

FIG. 32 illustrates an example of a quantum communication network model in a system applicable to the present disclosure.

FIG. 33 illustrates an example of a detailed procedure of a process of deriving multiple optimal paths in a system applicable to the present disclosure.

FIG. 34 illustrates an example of a quantum network including quantum nodes and quantum direct channel links in a system applicable to the present disclosure.

FIG. 35 illustrates an example of an optimal path search process (step (1) to step (3)) based on an OPS algorithm in a system applicable to the present disclosure.

FIG. 36 illustrates an example of an optimal path search process (step (4) to step (6)) based on an OPS algorithm in a system applicable to the present disclosure.

FIG. 37 illustrates an example of a network structure for quantum resource allocation (S: source node, D: destination node, C: coordinator) in which the coordinator exists outside the network topology in a system applicable to the present disclosure.

FIG. 38 illustrates an example of a network structure for quantum resource allocation (S: source node, D: destination node, C: coordinator) in which the coordinator exists within the network topology in a system applicable to the present disclosure.

FIG. 39 illustrates an example of a quantum resource allocation process based on a centralized optimal path search in a system applicable to the present disclosure.

FIG. 40 illustrates an example of a quantum resource allocation process based on a distributed optimal path search in a system applicable to the present disclosure.

FIG. 41 illustrates an example of an operation process of a coordinator node (centralized) in a system applicable to the present disclosure.

FIG. 42 illustrates an example of an operation process of a coordinator node (distributed) in a system applicable to the present disclosure.

FIG. 43 illustrates a communication system applied to various embodiments of the present disclosure.

FIG. 44 illustrates a wireless device applicable to various embodiments of the present disclosure.

FIG. 45 illustrates another example of a wireless device applicable to various embodiments of the present disclosure.

FIG. 46 illustrates a signal processing circuit for a transmission signal.

FIG. 47 illustrates another example of a wireless device applied to various embodiments of the present disclosure.

FIG. 48 illustrates a hand-held device applied to various embodiments of the present disclosure.

FIG. 49 illustrates a vehicle or an autonomous vehicle applied to various embodiments of the present disclosure.

FIG. 50 illustrates a vehicle applied to various embodiments of the present disclosure.

FIG. 51 illustrates an XR device applied to various embodiments of the present disclosure.

FIG. 52 illustrates a robot applied to various embodiments of the present disclosure.

FIG. 53 illustrates an AI device applied to various embodiments of the present disclosure.

### MODE FOR INVENTION

In various embodiments of the present disclosure, “A or B” may mean “only A,” “only B” or “both A and B.” In other words, in various embodiments of the present disclosure, “A or B” may be interpreted as “A and/or B.” For example, in various embodiments of the present disclosure, “A, B or C” may mean “only A,” “only B,” “only C” or “any combination of A, B and C.”

A slash (/) or comma used in various embodiments of the present disclosure may mean “and/or.” For example, “A/B” may mean “A and/or B.” Hence, “A/B” may mean “only A,” “only B” or “both A and B.” For example, “A, B, C” may mean “A, B, or C.”

In various embodiments of the present disclosure, “at least one of A and B” may mean “only A,” “only B” or “both A and B.” In addition, in various embodiments of the present disclosure, the expression of “at least one of A or B” or “at least one of A and/or B” may be interpreted in the same meaning as “at least one of A and B.”

Further, in various embodiments of the present disclosure, “at least one of A, B, and C” may mean “only A,” “only B,” “only C” or “any combination of A, B and C.” In addition, “at least one of A, B or C” or “at least one of A, B and/or C” may mean “at least one of A, B, and C.”

Further, parentheses used in various embodiments of the present disclosure may mean “for example.” Specifically, when “control information (PDCCH)” is described, “PDCCH” may be proposed as an example of “control information.” In other words, “control information” in various embodiments of the present disclosure is not limited to “PDCCH,” and “PDDCH” may be proposed as an example of “control information.” In addition, even when “control information (i.e., PDCCH)” is described, “PDCCH” may be proposed as an example of “control information.”

Technical features described individually in one drawing in various embodiments of the present disclosure may be implemented individually or simultaneously.

The following technology may be used in various radio access system including CDMA, FDMA, TDMA, OFDMA, SC-FDMA, and the like. The CDMA may be implemented as radio technology such as Universal Terrestrial Radio Access (UTRA) or CDMA2000. The TDMA may be implemented as radio technology such as a global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802.20, Evolved UTRA (E-UTRA), or the like. The UTRA is a part of Universal Mobile Telecommunications System (UMTS). 3rd Generation Partnership Project (3GPP) Long Term Evolution (LTE) is a part of Evolved UMTS (E-UMTS) using the E-UTRA and LTE-Advanced (A)/LTE-A pro is an evolved version of the 3GPP LTE. 3GPP NR (New Radio or New Radio Access Technology) is an evolved version of the 3GPP LTE/LTE-A/LTE-A pro. 3GPP 6G may be an evolved version of 3GPP NR.

For clarity in the description, the following description will mostly focus on 3GPP communication system (e.g. LTE-A or 5G NR). However, technical features according to an embodiment of the present disclosure will not be limited only to this. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a detailed standard document number. The LTE/NR/6G may be collectively referred to as the 3GPP system. For terms and techniques not specifically described among terms and techniques used in the present disclosure, reference may be made to a wireless communication standard document published before the present disclosure is filed. For example, the following document may be referred to.

### 3GPP LTE

36.211: Physical channels and modulation
36.212: Multiplexing and channel coding
36.213: Physical layer procedures
36.300: Overall description
36.331: Radio Resource Control (RRC)

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

### Physical Channel and Frame Structure

### Physical Channel and General Signal Transmission

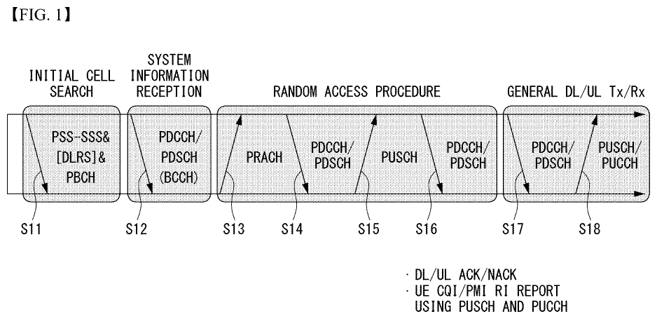

FIG. 1 illustrates an example of physical channels and general signal transmission used for the 3GPP system.

In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S11). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S12).

When there is no radio resource first accessing the eNB or for signal transmission, the UE may perform a Random Access Procedure (RACH) to the eNB (S13 to S16). To this end, the UE may transmit a specific sequence to a preamble through a Physical Random Access Channel (PRACH) (S13 and S15) and receive a response message (Random Access Response (RAR) message) for the preamble through the PDCCH and a corresponding PDSCH. In the case of a contention based RACH, a Contention Resolution Procedure may be additionally performed (S16).

The UE that performs the above procedure may then perform PDCCH/PDSCH reception (S17) and Physical Uplink Shared Channel (PUSCH)/Physical Uplink Control Channel (PUCCH) transmission (S18) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

The control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., via the PUSCH and/or PUCCH.

### Structure of Uplink and Downlink Channels

### Downlink Channel Structure

A base station transmits a related signal to a UE via a downlink channel to be described later, and the UE receives the related signal from the base station via the downlink channel to be described later.

### (1) Physical Downlink Shared Channel (PDSCH)

A PDSCH carries downlink data (e.g., DL-shared channel transport block, DL-SCH TB) and is applied with a modulation method such as quadrature phase shift keying (QPSK), 16 quadrature amplitude modulation (QAM), 64 QAM, and 256 QAM. A codeword is generated by encoding TB. The PDSCH may carry multiple codewords. Scrambling and modulation mapping are performed for each codeword, and modulation symbols generated from each codeword are mapped to one or more layers (layer mapping). Each layer is mapped to a resource together with a demodulation reference signal (DMRS) to generate an OFDM symbol signal, and is transmitted through a corresponding antenna port.

### (2) Physical Downlink Control Channel (PDCCH)

A PDCCH carries downlink control information (DCI) and is applied with a QPSK modulation method, etc. One PDCCH consists of 1, 2, 4, 8, or 16 control channel elements (CCEs) based on an aggregation level (AL). One CCE consists of 6 resource element groups (REGs). One REG is defined by one OFDM symbol and one (P) RB.

The UE performs decoding (aka, blind decoding) on a set of PDCCH candidates to acquire DCI transmitted via the PDCCH. The set of PDCCH candidates decoded by the UE is defined as a PDCCH search space set. The search space set may be a common search space or a UE-specific search space. The UE may acquire DCI by monitoring PDCCH candidates in one or more search space sets configured by MIB or higher layer signaling.

### Uplink Channel Structure

A UE transmits a related signal to a base station via an uplink channel to be described later, and the base station receives the related signal from the UE via the uplink channel to be described later.

### (1) Physical Uplink Shared Channel (PUSCH)

A PUSCH carries uplink data (e.g., UL-shared channel transport block, UL-SCH TB) and/or uplink control information (UCI) and is transmitted based on a CP-OFDM (Cyclic Prefix-Orthogonal Frequency Division Multiplexing) waveform, DFT-s-OFDM (Discrete Fourier Transform-spread-Orthogonal Frequency Division Multiplexing) waveform, or the like. When the PUSCH is transmitted based on the DFT-s-OFDM waveform, the UE transmits the PUSCH by applying a transform precoding. For example, if the transform precoding is not possible (e.g., transform precoding is disabled), the UE may transmit the PUSCH based on the CP-OFDM waveform, and if the transform precoding is possible (e.g., transform precoding is enabled), the UE may transmit the PUSCH based on the CP-OFDM waveform or the DFT-s-OFDM waveform. The PUSCH transmission may be dynamically scheduled by an UL grant within DCI, or may be semi-statically scheduled based on high layer (e.g., RRC) signaling (and/or layer 1 (L1) signaling (e.g., PDCCH)) (configured grant). The PUSCH transmission may be performed based on a codebook or a non-codebook.

### (2) Physical Uplink Control Channel (PUCCH)

A PUCCH carries uplink control information, HARQ-ACK, and/or scheduling request (SR), and may be divided into multiple PUCCHs based on a PUCCH transmission length.

New radio access technology (RAT, NR) is described below.

As more and more communication devices require larger communication capacity, there is a need for enhanced mobile broadband communication compared to the existing radio access technology (RAT). Massive machine type communications (MTCs) which provide various services anytime and anywhere by connecting many devices and objects are also one of the major issues to be considered in next-generation communications. In addition, a communication system design considering a service/UE sensitive to reliability and latency is also being discussed. As above, the introduction of next generation radio access technology considering enhanced mobile broadband communication, massive MTC, ultra-reliable and low latency communication (URLLC), etc. is discussed, and the technology is called new RAT or NR for convenience in various embodiments of the present disclosure.

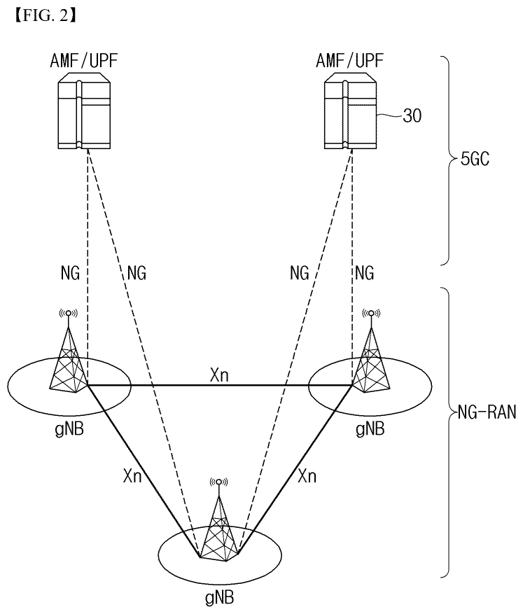

FIG. 2 illustrates system architecture of new generation radio access network (NG-RAN).

Referring to FIG. 2, the NG-RAN may include gNB and/or eNB providing user plane and control plane protocol terminations toward the UE. FIG. 2 illustrates an example where the NG-RAN includes only the gNB. The gNB and the eNB are interconnected via Xn interface. The gNB and the eNB are connected to the 5G core network (5GC) via NG interface. More specifically, the gNB and the eNB are connected to an access and mobility management function (AMF) via NG-C interface and connected to a user plane function (UPF) via NG-U interface.

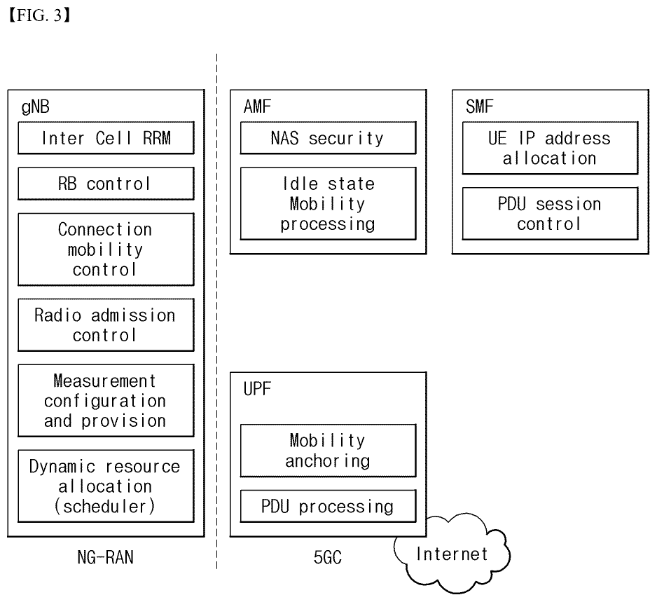

FIG. 3 illustrates functional split between NG-RAN and 5GC.

Referring to FIG. 3, the gNB may provide functions including Inter Cell RRM, RB control, connection mobility control, radio admission control, measurement configuration and provision, dynamic resource allocation, etc. The AMF may provide functions including non-access stratum (NAS) security, idle state mobility processing, etc. The UPF may provide functions including mobility anchoring, protocol data unit (PDU) processing, etc. The session management function (SMF) may provide functions including UE IP address allocation, PDU session control, etc.

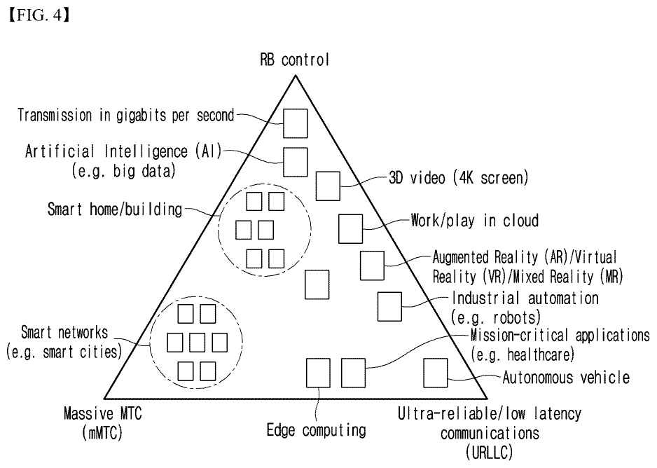

FIG. 4 illustrates an example of 5G usage scenario.

The 5G usage scenario illustrated in FIG. 4 is merely an example, and technical features according to various embodiments of the present disclosure can be applied to other 5G usage scenarios that are not illustrated in FIG. 4.

Referring to FIG. 4, three major requirement areas of 5G include (1) an enhanced mobile broadband (eMBB) area, (2) a massive machine type communication (mMTC) area and (3) an ultra-reliable and low latency communications (URLLC) area. Some use cases may require multiple areas for optimization, and other use case may focus only on one key performance indicator (KPI). 5G intends to support such diverse use cases in a flexible and reliable way.

eMBB focuses on across-the-board enhancements to the data rate, latency, user density, capacity and coverage of mobile broadband access. eMBB targets throughput of about 10 Gbps. eMBB goes far beyond basic mobile Internet access and covers rich interactive work, media and entertainment applications in the cloud or augmented reality. Data will be one of the key drivers for 5G and in new parts of this system we may for the first time see no dedicated voice service in the 5G era. In 5G, voice is expected to be handled as an application, simply using the data connectivity provided by the communication system. The main drivers for the increased traffic volume include an increase in size of content and an increase in the number of applications requiring high data transfer rates. Streaming service (audio and video), interactive video and mobile Internet connectivity will continue to be used more broadly as more devices connect to the Internet. Many of these applications require always-on connectivity to push real time information and notifications to the users. Cloud storage and applications are rapidly increasing for mobile communication platforms. This is applicable for both work and entertainment. Cloud storage is one particular use case driving the growth of uplink data transfer rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality for entertainment and information retrieval. The augmented reality requires very low latencies and significant instant data volumes.

mMTC is designed to enable communication between devices that are low-cost, massive in number and battery-driven, and is intended to support applications such as smart metering, logistics, and field and body sensors. mMTC targets batteries with a lifespan of about 10 years and/or about 1 million devices per km2. mMTC enables to smoothly connect embedded sensors in all fields and is one of the most expected 5G use case. It is predicted that IoT devices will potentially reach 20.4 billion by 2020. Industrial IoT is one area where 5G will play a major role, enabling smart cities, asset tracking, smart utilities, agriculture, and security infrastructure.

URLLC will make it possible for devices and machines to communicate with ultra-reliability, very low latency and high availability, making it ideal for vehicular communication, industrial control, factory automation, remote surgery, smart grids and public safety applications. URLLC targets latency of about 1 ms. URLLC includes new services that will transform industries with ultra-reliable/low latency links like remote control of critical infrastructure and an autonomous vehicle. The level of reliability and latency is vital to smart grid control, industrial automation, robotics, and drone control and coordination.

Next, multiple use cases included within the triangle of FIG. 4 are described in more detail.

5G may supplement fiber-to-the-home (FTTH) and cable-based broadband (or DOCSIS) as means for providing a stream evaluated from gigabits per second to several hundreds of megabits per second. Such fast speed may be necessary to deliver TV with resolution of 4K or more (6K, 8K or more) in addition to virtual reality (VR) and augmented reality (AR). VR and AR applications include immersive sports games. A specific application may require special network configuration. For example, in the VR game, in order for game companies to minimize latency, a core server may need to be integrated with an edge network server of a network operator.

The automotive sector is expected to be an important new driver for 5G, along with many use cases for mobile communications for vehicles. For example, entertainment for passengers requires high capacity and high mobile broadband at the same time. The reason for this is that future users will expect to continue their good quality connection independent of their location and speed. Other use cases for the automotive sector are augmented reality dashboards. The augmented reality dashboards display overlay information on top of what a driver is seeing through the front window through the augmented reality dashboards, identifying objects in the dark and telling the driver about the distances and movements of the objects. In the future, wireless modules will enable communication between vehicles, information exchange between vehicles and supporting infrastructure, and information exchange between vehicles and other connected devices (e.g., devices carried by pedestrians). Safety systems guide drivers on alternative courses of action to allow them to drive more safely and lower the risks of accidents. A next phase will be a remotely controlled vehicle or an autonomous vehicle. This requires ultra reliable and very fast communication between different autonomous vehicles and/or between vehicles and infrastructure. In the future, an autonomous vehicle may take care of all driving activity, allowing the driver to rest and concentrate only on traffic anomalies that the vehicle itself cannot identify. The technical requirements for autonomous vehicles require for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost and energy-efficient maintenance of the city or home. A similar setup can be done for each home, where temperature sensors, window and heating controllers, burglar alarms and home appliances are all connected wirelessly. Many of these sensors are typically low data rate, low power and low cost. However, for example, real time HD video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information can include the behaviors of suppliers and consumers, allowing the smart grid to improve the efficiency, reliability, economics and sustainability of the production and distribution of fuels such as electricity in an automated fashion. A smart grid can be seen as another sensor network with low delays.

The health sector has many applications that can benefit from mobile communications. Communications systems enable telemedicine, which provides clinical health care at a distance. It helps eliminate distance barriers and can improve access to medical services that would often not be consistently available in distant rural communities. It is also used to save lives in critical care and emergency situations. Wireless sensor networks based on mobile communication can provide remote monitoring and sensors for parameters such as heart rate and blood pressure.

Wireless and mobile communications are becoming increasingly important for industrial application. Wires are expensive to install and maintain. Therefore, the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Logistics and freight tracking are important use cases for mobile communications that enable the tracking of inventory and packages wherever they are through using location based information systems. The logistics and freight use cases typically require lower data rates but need wide coverage and reliable location information.

Examples of next generation communication (e.g., 6G) that can be applied to various embodiments of the present disclosure are described below.

### 6G System General

A 6G (wireless communication) system has purposes such as (i) a very high data rate per device, (ii) a very large number of connected devices, (iii) global connectivity, (iv) a very low latency, (v) a reduction in energy consumption of battery-free IoT devices, (vi) ultra-reliable connectivity, and (vii) connected intelligence with machine learning capability. The vision of the 6G system may include four aspects such as intelligent connectivity, deep connectivity, holographic connectivity, and ubiquitous connectivity, and the 6G system may satisfy the requirements shown in Table 1 below. That is, Table 1 shows an example of the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

The 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion, and enhanced data security.

FIG. 5 illustrates an example of a communication structure providable in a 6G system.

The 6G system is expected to have 50 times greater simultaneous wireless communication connectivity than a 5G wireless communication system. URLLC, which is the key feature of 5G, will become more important technology by providing an end-to-end latency less than 1 ms in 6G communication. The 6G system may have much better volumetric spectrum efficiency unlike frequently used domain spectrum efficiency. The 6G system can provide advanced battery technology for energy harvesting and very long battery life, and thus mobile devices may not need to be separately charged in the 6G system. In 6G, new network characteristics may be as follows.
Satellites integrated network: To provide a global mobile group, 6G will be integrated with satellite. Integration of terrestrial, satellite and public networks into one wireless communication system is critical for 6G.
Connected intelligence: Unlike the wireless communication systems of previous generations, 6G is innovative and may update wireless evolution from “connected things” to “connected intelligence”. AI may be applied in each step (or each signal processing procedure to be described later) of a communication procedure.
Seamless integration of wireless information and energy transfer: A 6G wireless network may transfer power to charge batteries of devices such as smartphones and sensors. Therefore, wireless information and energy transfer (WIET) will be integrated.
Ubiquitous super 3D connectivity: Access to networks and core network functions of drone and very low earth orbit satellite will establish super 3D connectivity in 6G ubiquitous.

In the new network properties cs of 6G described above, several general requirements may be as follows.
Small cell networks: The idea of a small cell network has been introduced to improve received signal quality as a result of throughput, energy efficiency, and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network consisting of heterogeneous networks improves overall QoS and reduces costs.
High-capacity backhaul: Backhaul connectivity is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability. Further, billions of devices can be shared on a shared physical infrastructure.

### Core Implementation Technology of 6G System

### Artificial Intelligence (AI)

Technology which is most important in the 6G system and will be newly introduced is AI. AI was not involved in the 4G system. The 5G system will support partial or very limited AI. However, the 6G system will support AI for full automation. Advance in machine learning will create a more intelligent network for real-time communication in 6G. When AI is introduced to communication, real-time data transmission can be simplified and improved. AI may determine a method of performing complicated target tasks using countless analysis. That is, AI can increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, and in particular, deep learning has been focused on the wireless resource management and allocation field. However, such studies have been gradually developed to the MAC layer and the physical layer, and in particular, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. The machine learning may also be used for antenna selection, power control, symbol detection, etc. in the MIMO system.

However, application of a deep neutral network (DNN) for transmission in the physical layer may have the following problems.

A deep learning based AI algorithm requires a lot of training data in order to optimize training parameters. However, due to limitations in acquiring data in a specific channel environment as the training data, a lot of training data is used offline. Static training for the training data in the specific channel environment may cause a contradiction between the diversity and dynamic characteristics of a radio channel.

Currently, the deep learning mainly targets real signals. However, signals of the physical layer of wireless communication are complex signals. For matching of the characteristics of a wireless communication signal, studies on a neural network for detecting a complex domain signal are further required.

Hereinafter, machine learning is described in more detail.

Machine learning refers to a series of operations to train a machine in order to create a machine capable of doing tasks that people cannot do or are difficult for people to do. Machine learning requires data and learning models. In the machine learning, a data learning method may be roughly divided into three methods, that is, supervised learning, unsupervised learning and reinforcement learning.

Neural network learning is to minimize an output error. The neural network learning refers to a process of repeatedly inputting training data to a neural network, calculating an error of an output and a target of the neural network for the training data, backpropagating the error of the neural network from an output layer to an input layer of the neural network for the purpose of reducing the error, and updating a weight of each node of the neural network.

The supervised learning may use training data labeled with a correct answer, and the unsupervised learning may use training data which is not labeled with a correct answer. That is, for example, in supervised learning for data classification, training data may be data in which each training data is labeled with a category. The labeled training data may be input to the neural network, and the error may be calculated by comparing the output (category) of the neural network with the label of the training data. The calculated error is backpropagated in the neural network in the reverse direction (i.e., from the output layer to the input layer), and a connection weight of respective nodes of each layer of the neural network may be updated based on the backpropagation. Change in the updated connection weight of each node may be determined depending on a learning rate. The calculation of the neural network for input data and the backpropagation of the error may construct a learning cycle (epoch). The learning rate may be differently applied based on the number of repetitions of the learning cycle of the neural network. For example, in the early stage of learning of the neural network, efficiency can be increased by allowing the neural network to rapidly ensure a certain level of performance using a high learning rate, and in the late of learning, accuracy can be increased using a low learning rate.

The learning method may vary depending on the feature of data. For example, in order for a reception end to accurately predict data transmitted from a transmission end on a communication system, it is preferable that learning is performed using the supervised learning rather than the unsupervised learning or the reinforcement learning.

The learning model corresponds to the human brain and may be regarded as the most basic linear model. However, a paradigm of machine learning using, as the learning model, a neural network structure with high complexity, such as artificial neural networks, is referred to as deep learning.

Neural network cores used as the learning method may roughly include a deep neural network (DNN) method, a convolutional deep neural network (CNN) method, and a recurrent Boltzmann machine (RNN) method.

The artificial neural network is an example of connecting several perceptrons.

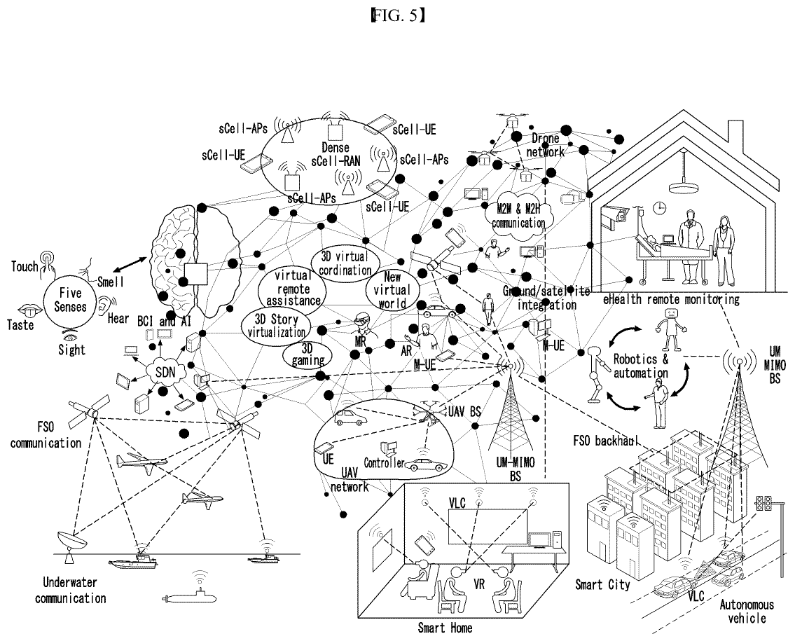

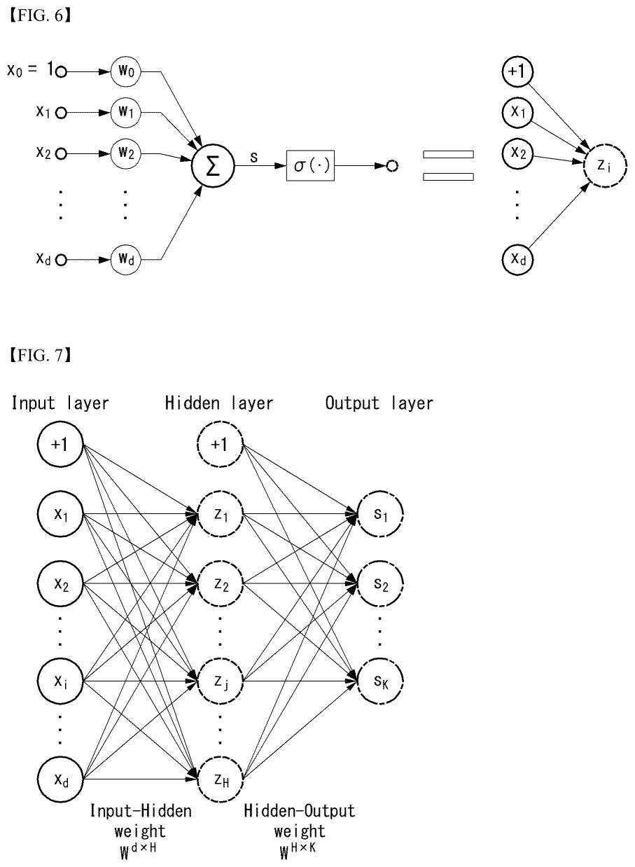

FIG. 6 illustrates an example of a structure of a perceptron.

Referring to FIG. 6, when an input vector x=(x1, x2, . . . , xd) is input, each component is multiplied by a weight (W1, W2, . . . , Wd), and all the results are summed. After that, the entire process of applying an activation function σ(·) is called a perceptron. The huge artificial neural network structure may extend the simplified perceptron structure illustrated in FIG. 6 to apply the input vector to different multidimensional perceptrons. For convenience of explanation, an input value or an output value is referred to as a node.

The perceptron structure illustrated in FIG. 6 may be described as consisting of a total of three layers based on the input value and the output value. FIG. 7 illustrates an artificial neural network in which the number of (d+1) dimensional perceptrons between a first layer and a second layer is H, and the number of (H+1) dimensional perceptrons between the second layer and a third layer is K, by way of example.

FIG. 7 illustrates an example of a structure of a multilayer perceptron.

A layer where the input vector is located is called an input layer, a layer where a final output value is located is called an output layer, and all layers located between the input layer and the output layer are called a hidden layer. FIG. 7 illustrates three layers, by way of example. However, since the number of layers of the artificial neural network is counted excluding the input layer, it can be seen as a total of two layers. The artificial neural network is constructed by connecting the perceptrons of a basic block in two dimensions.

The above-described input layer, hidden layer, and output layer can be jointly applied in various artificial neural network structures, such as CNN and RNN to be described later, as well as the multilayer perceptron. The greater the number of hidden layers, the deeper the artificial neural network is, and a machine learning paradigm that uses the sufficiently deep artificial neural network as a learning model is called deep learning. In addition, the artificial neural network used for deep learning is called a deep neural network (DNN).

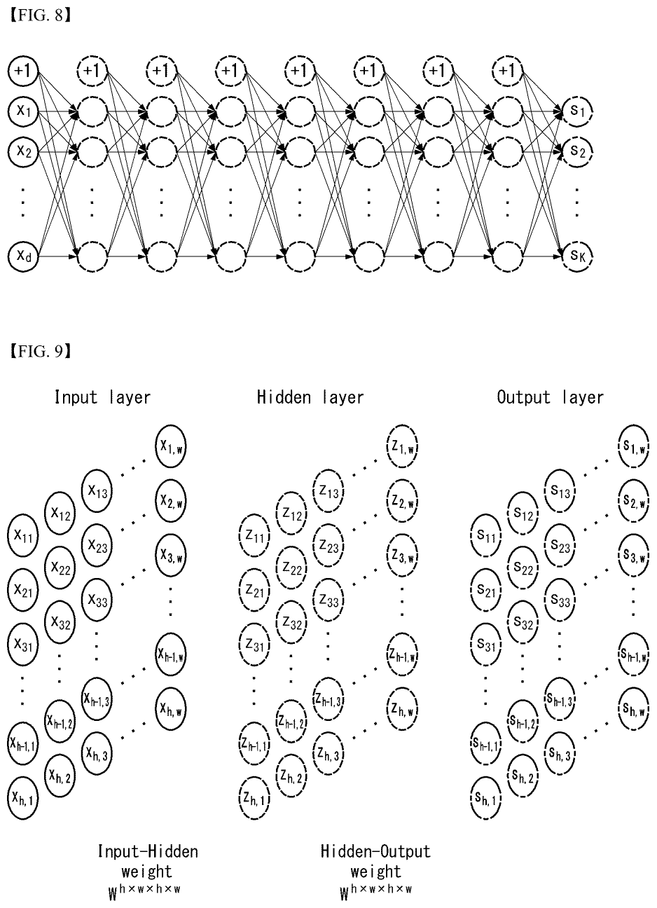

FIG. 8 illustrates an example of a deep neural network.

The deep neural network illustrated in FIG. 8 is a multilayer perceptron consisting of eight hidden layers+eight output layers. The multilayer perceptron structure is expressed as a fully connected neural network. In the fully connected neural network, a connection relationship does not exist between nodes located at the same layer, and a connection relationship exists only between nodes located at adjacent layers. The DNN has a fully connected neural network structure and is composed of a combination of multiple hidden layers and activation functions, so it can be usefully applied to understand correlation characteristics between input and output. The correlation characteristic may mean a joint probability of input and output.

Based on how the plurality of perceptrons are connected to each other, various artificial neural network structures different from the above-described DNN can be formed.

FIG. 9 illustrates an example of a structure of a convolutional neural network.

In the DNN, nodes located inside one layer are arranged in a one-dimensional longitudinal direction. However, in FIG. 9, it may be assumed that w nodes horizontally and h nodes vertically are arranged in two dimensions (convolutional neural network structure of FIG. 9). In this case, since in a connection process leading from one input node to the hidden layer, a weight is given for each connection, a total of h×w weights needs to be considered. Since there are h×w nodes in the input layer, a total of h2w2 weights are required between two adjacent layers.

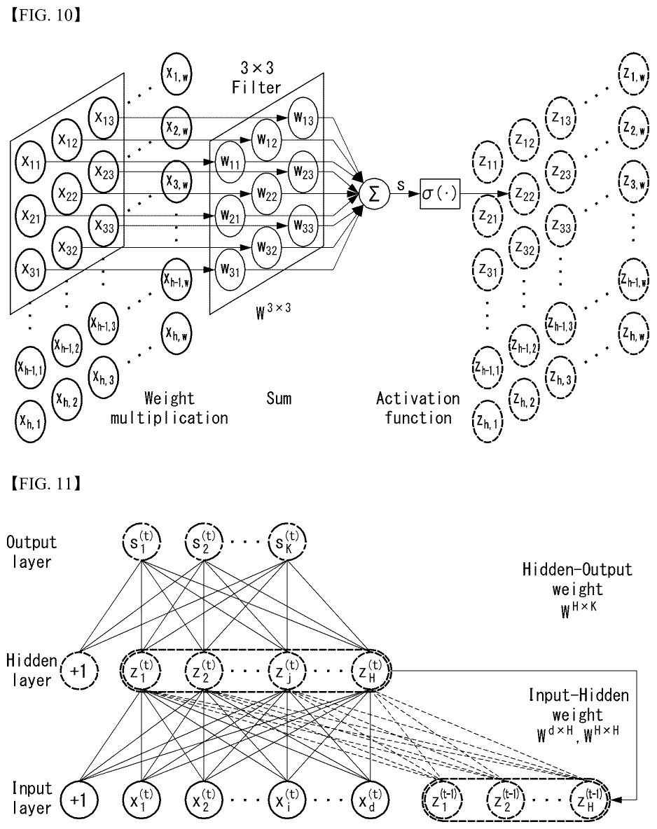

The convolutional neural network of FIG. 9 has a problem in that the number of weights increases exponentially depending on the number of connections. Therefore, instead of considering the connections of all the nodes between adjacent layers, it is assumed that a small-sized filter exists, and a weighted sum and an activation function calculation are performed on an overlap portion of the filters as illustrated in FIG. 10.

FIG. 10 illustrates an example of a filter operation of a convolutional neural network.

One filter has a weight corresponding to the number as much as its size, and learning of the weight may be performed so that a certain feature on an image can be extracted and output as a factor. In FIG. 10, a filter having a size of 3×3 is applied to the upper leftmost 3×3 area of the input layer, and an output value obtained by performing a weighted sum and an activation function calculation for a corresponding node is stored in z22.

The filter performs the weighted sum and the activation function calculation while moving horizontally and vertically by a predetermined interval when scanning the input layer, and places the output value at a location of a current filter. This calculation method is similar to the convolution operation on images in the field of computer vision. Thus, a deep neural network with this structure is referred to as a convolutional neural network (CNN), and a hidden layer generated as a result of the convolution operation is referred to as a convolutional layer. In addition, a neural network in which a plurality of convolutional layers exists is referred to as a deep convolutional neural network (DCNN).

At the node where a current filter is located at the convolutional layer, the number of weights may be reduced by calculating a weighted sum including only nodes located in an area covered by the filter. Hence, one filter can be used to focus on features for a local area. Accordingly, the CNN can be effectively applied to image data processing in which a physical distance on the 2D area is an important criterion. In the CNN, a plurality of filters may be applied immediately before the convolution layer, and a plurality of output results may be generated through a convolution operation of each filter.

There may be data whose sequence characteristics are important depending on data attributes. A structure, in which a method of inputting one element on the data sequence at each time step considering a length variability and a relationship of the sequence data and inputting an output vector (hidden vector) of a hidden layer output at a specific time step together with a next element on the data sequence is applied to the artificial neural network, is referred to as a recurrent neural network structure.

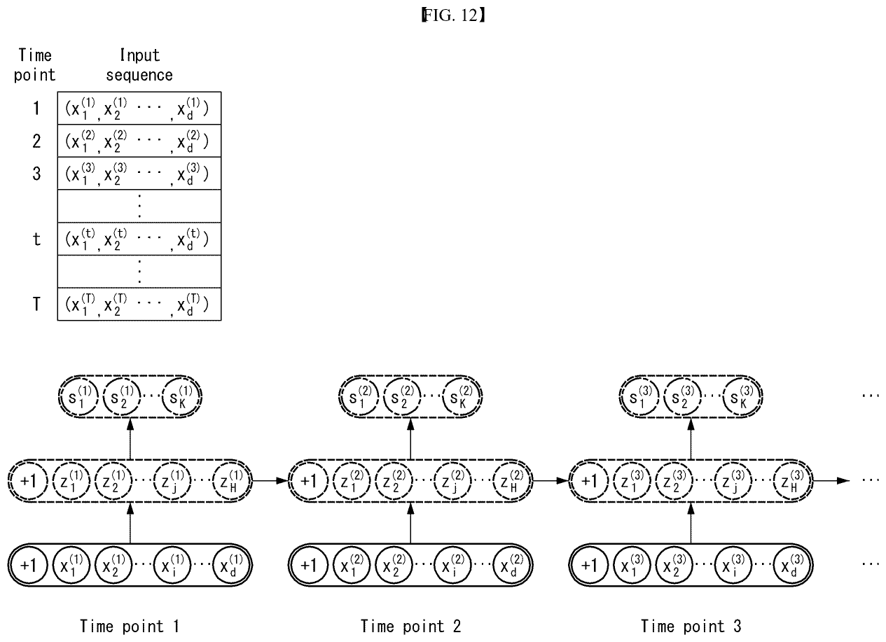

FIG. 11 illustrates an example of a neural network structure in which a circular loop exists.

Referring to FIG. 11, a recurrent neural network (RNN) is a structure in which in a process of inputting elements (x1(t), x2(t), . . . , xd(t)) of any line of sight ‘t’ on a data sequence to a fully connected neural network, hidden vectors (z1(t−1), z2(t−1), . . . , zH(t−1)) are input together at an immediately previous time step (t−1) to apply a weighted sum and an activation function. A reason for transferring the hidden vectors at a next time step is that information within the input vector in previous time steps is considered to be accumulated on the hidden vectors of a current time step.

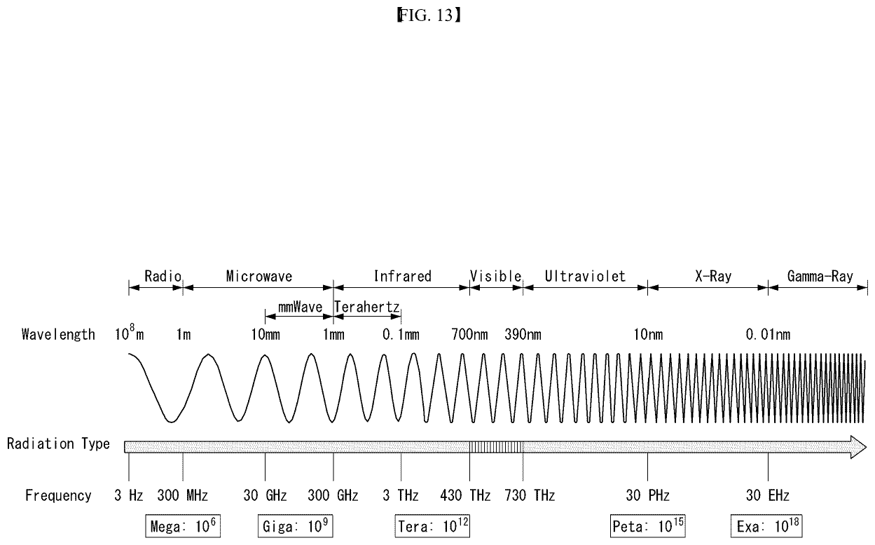

FIG. 12 illustrates an example of an operation structure of a recurrent neural network.

Referring to FIG. 12, the recurrent neural network operates in a predetermined order of time with respect to an input data sequence.

Hidden vectors (z1(1), z2(1), . . . , zH(1)) when input vectors (x1(t), x2(t), . . . , xd(t)) at a time step 1 are input to the recurrent neural network, are input together with input vectors (x1(2), x2(2), . . . , xd(2)) at a time step 2 to determine vectors (z1(2), z2(2), . . . , zH(2)) of a hidden layer through a weighted sum and an activation function. This process is repeatedly performed at time steps 2, 3, . . . , T.

When a plurality of hidden layers are disposed in the recurrent neural network, this is referred to as a deep recurrent neural network (DRNN). The recurrent neural network is designed to be usefully applied to sequence data (e.g., natural language processing).

A neural network core used as a learning method includes various deep learning methods such as a restricted Boltzmann machine (RBM), a deep belief network (DBN), and a deep Q-network, in addition to the DNN, the CNN, and the RNN, and may be applied to fields such as computer vision, speech recognition, natural language processing, and voice/signal processing.

Recently, attempts to integrate AI with a wireless communication system have appeared, but this has been concentrated in the field of wireless resource management and allocation in the application layer, network layer, in particular, deep learning. However, such research is gradually developing into the MAC layer and the physical layer, and in particular, attempts to combine deep learning with wireless transmission in the physical layer have appeared. The AI-based physical layer transmission refers to applying a signal processing and communication mechanism based on an AI driver, rather than a traditional communication framework in the fundamental signal processing and communication mechanism. For example, deep learning-based channel coding and decoding, deep learning-based signal estimation and detection, deep learning-based MIMO mechanism, AI-based resource scheduling and allocation, and the like, may be included.

### Terahertz (THz) Communication

A data transfer rate can be increased by increasing the bandwidth. This can be performed by using sub-TH communication as a wide bandwidth and applying advanced massive MIMO technology. THz waves, which are known as sub-millimeter radiation, generally indicate a frequency band between 0.1 THz and 10 THz with the corresponding wavelengths in the range of 0.03 mm-3 mm. A band range of 100 GHz to 300 GHz (sub THz band) is regarded as a main part of the THz band for cellular communication. When the sub-THz band is added to the mmWave band, the 6G cellular communication capacity increases. 300 GHz-3 THz among the defined THz band is in a far infrared (IR) frequency band. Although the 300 GHz-3 THz band is part of the optical band, it is at the border of the optical band and is immediately after the RF band. Therefore, this 300 GHz-3 THz band shows similarity with RF.

FIG. 13 illustrates an example of an electromagnetic spectrum.

The main characteristics of THz communication include (i) a bandwidth widely available to support a very high data transfer rate and (ii) a high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band. Through this, an advanced adaptive arrangement technology capable of overcoming a range limitation can be used.

### Optical Wireless Technology

Optical wireless communication (OWC) technologies are envisioned for 6G communication in addition to RF based communications for all possible device-to-access networks.

These networks access network-to-backhaul/fronthaul network connectivity. The OWC technologies have already been used since 4G communication systems, but will be used more widely to meet the demands of the 6G communication system. The OWC technologies, such as light fidelity, visible light communication, optical camera communication, and FSO communication based on the optical band, are already well-known technologies. Communications based on wireless optical technologies can provide very high data rates, low latencies, and secure communications. LiDAR, which is also based on the optical band, is a promising technology for very high-resolution 3D mapping in 6G communications.

### FSO Backhaul Network

Characteristics of a transmitter and a receiver of the FSO system are similar to characteristics of an optical fiber network. Therefore, data transmission of the FSO system similar to that of the optical fiber system. Accordingly, FSO can be a good technology for providing backhaul connectivity in the 6G system along with the optical fiber network. If FSO is used, very long-distance communication is possible even at a distance of 10,000 km or more. FSO supports massive backhaul connectivity for remote and non-remote areas such as sea, space, underwater, and isolated islands. FSO also supports cellular BS connectivity.

### Massive MIMO Technology

One of core technologies for improving spectral efficiency is to apply MIMO technology. When the MIMO technology is improved, the spectral efficiency is also improved. Therefore, massive MIMO technology will be important in the 6G system. Since the MIMO technology uses multiple paths, multiplexing technology and beam generation and management technology suitable for the THz band should be significantly considered so that data signals can be transmitted through one or more paths.

### Block Chain

A block chain will be an important technology for managing large amounts of data in future communication systems. The block chain is a form of distributed ledger technology, and the distributed ledger is a database distributed across numerous nodes or computing devices. Each node duplicates and stores the same copy of the ledger. The block chain is managed by a P2P network. This may exist without being managed by a centralized institution or server. Block chain data is collected together and is organized into blocks. The blocks are connected to each other and protected using encryption. The block chain completely complements large-scale IoT through improved interoperability, security, privacy, stability, and scalability. Accordingly, the block chain technology provides several functions such as interoperability between devices, high-capacity data traceability, autonomous interaction of different IoT systems, and large-scale connection stability of 6G communication systems.

### 3D Networking

The 6G system integrates the ground and air networks to support communications for users in the vertical extension. The 3D BSs will be provided by low-orbit satellites and UAVs. The addition of new dimensions in terms of height and the associated degrees of freedom makes 3D connectivity significantly different from traditional 2D networks.

### Quantum Communication

Unsupervised reinforcement learning in networks is promising in the context of 6G networks. Supervised learning approaches will not be practical for labeling large amounts of data generated in 6G. Unsupervised learning does not require labeling. Therefore, this technique can be used to create the representations of complex networks autonomously. By combining reinforcement learning and unsupervised learning, it is possible to operate the network truly autonomously.

### Unmanned Aerial Vehicle

An unmanned aerial vehicle (UAV) or drone will be an important factor in 6G wireless communication. In most cases, a high-speed data wireless connection is provided using UAV technology. A BS entity is installed in the UAV to provide cellular connectivity. The UAVs have specific features, which are not found in fixed BS infrastructures, such as easy deployment, strong line-of-sight links, and mobility-controlled degrees of freedom. During emergencies such as natural disasters, the deployment of terrestrial telecommunications infrastructure is not economically feasible and sometimes services cannot be provided in volatile environments. The UAV can easily handle this situation. The UAV will be a new paradigm in the field of wireless communications. This technology facilitates the three basic requirements of wireless networks, such as eMBB, URLLC, and mMTC. The UAV can also support a number of purposes, such as network connectivity improvement, fire detection, disaster emergency services, security and surveillance, pollution monitoring, parking monitoring, and accident monitoring. Therefore, UAV technology is recognized as one of the most important technologies for 6G communication.

### Cell-Free Communication

The tight integration of multiple frequencies and different communication technologies is very important in 6G systems. As a result, the user can move seamlessly from one network to another network without the need for making any manual configurations in the device. The best network is automatically selected from the available communication technology. This will break the limits of the concept of cells in wireless communications. Currently, the user's movement from one cell to another cell causes too many handovers in dense networks, and also causes handover failures, handover delays, data losses, and the ping-pong effect. The 6G cell-free communications will overcome all these and provide better QoS. Cell-free communication will be achieved through multi-connectivity and multi-tier hybrid techniques and by different and heterogeneous radios in the devices.

### Integration of Wireless Information and Energy Transfer (WIET)

WIET uses the same field and wave as a wireless communication system. In particular, a sensor and a smartphone will be charged using wireless power transfer during communication. WIET is a promising technology for extending the life of battery charging wireless systems. Therefore, devices without battery will be supported in 6G communication.

### Integration of Sensing and Communication

An autonomous wireless network is a function for continuously detecting a dynamically changing environment state and exchanging information between different nodes. In 6G, sensing will be tightly integrated with communication to support autonomous systems.

### Integration of Access Backhaul Network

In 6G, the density of access networks will be enormous. Each access network is connected by optical fiber and backhaul connectivity such as FSO network. To cope with a very large number of access networks, there will be a tight integration between the access and backhaul networks.

### Hologram Beamforming

Beamforming is a signal processing procedure that adjusts an antenna array to transmit radio signals in a specific direction. This is a subset of smart antennas or advanced antenna systems. Beamforming technology has several advantages, such as high signal-to-noise ratio, interference prevention and rejection, and high network efficiency. Hologram beamforming (HBF) is a new beamforming method that differs significantly from MIMO systems because this uses a software-defined antenna. HBF will be a very effective approach for efficient and flexible transmission and reception of signals in multi-antenna communication devices in 6G.

### Big Data Analysis

Big data analysis is a complex process for analyzing various large data sets or big data. This process finds information such as hidden data, unknown correlations, and customer disposition to ensure complete data management. Big data is collected from various sources such as video, social networks, images and sensors. This technology is widely used for processing massive data in the 6G system.

### Large Intelligent Surface (LIS)

In the THz band signal, since the straightness is strong, there may be many shaded areas due to obstacles. By installing the LIS near these shaded areas, LIS technology, that expands a communication area, enhances communication stability, and enables additional optional services, becomes important. The LIS is an artificial surface made of electromagnetic materials, and can change propagation of incoming and outgoing radio waves. The LIS can be viewed as an extension of massive MIMO, but is different from the massive MIMO in an array structure and an operating mechanism. Further, the LIS has an advantage such as low power consumption, because this operates as a reconfigurable reflector with passive elements, that is, signals are only passively reflected without using active RF chains. In addition, since each of the passive reflectors of the LIS has to independently adjust the phase shift of an incident signal, this may be advantageous for wireless communication channels. By properly adjusting the phase shift through an LIS controller, the reflected signal can be collected at a target receiver to boost the received signal power.

### Terahertz (THz) Wireless Communication General

THz wireless communication uses wireless communication using a THz wave having a frequency of approximately 0.1 to 10 THz (1 THz=1012 Hz) and may refer to THz band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays, has a shorter wavelength than the RF/millimeter wave to have high straightness, and is capable of beam convergence. In addition, the photon energy of the THz wave is only a few meV and thus is harmless to the human body. A frequency band which is expected to be used for THz wireless communication may be D-band (110 GHz to 170 GHz) or H-band (220 GHz to 325 GHz) band with a low propagation loss due to molecular absorption in air. Standardization discussion on THz wireless communication is being discussed mainly in IEEE 802.15 THz working group in addition to 3GPP, and standard documents issued by a task group of IEEE 802.15 (e.g., TG3d, TG3e) can specify and supplement the description of the present disclosure. The THz wireless communication may be applied to wireless cognition, sensing, imaging, wireless communication, THz navigation, etc.

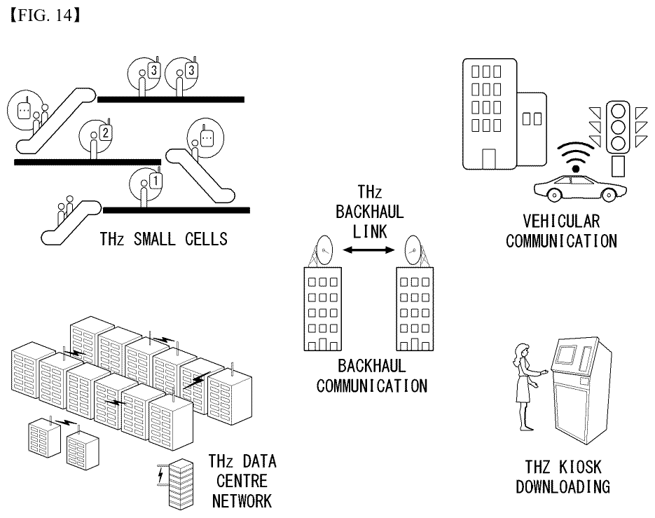

FIG. 14 illustrates an example of a THz communication application.

As illustrated in FIG. 14, a THz wireless communication scenario may be classified into a macro network, a micro network, and a nanoscale network. In the macro network, THz wireless communication may be applied to vehicle-to-vehicle connectivity and backhaul/fronthaul connectivity. In the micro network, THz wireless communication may be applied to near-field communication such as indoor small cells, fixed point-to-point or multi-point connection such as wireless connection in a data center, and kiosk downloading.

Table 2 below shows an example of technology which can be used in the THz wave.

TABLE 2

| | |
|---|---|
| Transceivers Device | Available immature: UTC-PD, RTD and SBD |
| Modulation | Low order modulation techniques (OOK, QPSK), |
| and coding | LDPC, Reed Soloman, Hamming, Polar, Turbo |
| Antenna | Omni and Directional, phased array with |
| | low number of antenna elements |
| Bandwidth | 69 GHz (or 23 GHz) at 300 GHz |
| Channel models | Partially |
| Data rate | 100 Gbps |
| Outdoor deployment | No |
| Free space loss | High |
| Coverage | Low |
| Radio Measurements | 300 GHz indoor |
| Device size | Few micrometers |

THz wireless communication can be classified based on a method for generating and receiving THz. The method of generating THz can be classified as an optical device or an electronic device-based technology.

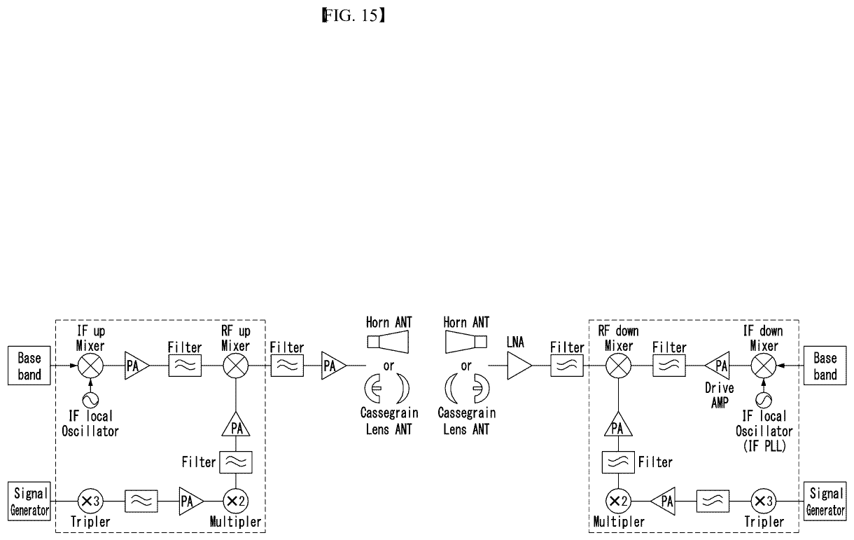

FIG. 15 illustrates an example of an electronic device-based THz wireless communication transceiver.

The method of generating THz using an electronic device includes a method using a semiconductor device such as a resonant tunneling diode (RTD), a method using a local oscillator and a multiplier, a monolithic microwave integrated circuit (MMIC) method using a compound semiconductor high electron mobility transistor (HEMT) based integrated circuit, a method using a Si-CMOS based integrated circuit, and the like. In FIG. 15, a multiplier (e.g., doubler, tripler) is applied to increase the frequency, and radiation is performed by an antenna via a subharmonic mixer. Since the THz band forms a high frequency, the multiplier is essential. Here, the multiplier is a circuit that allows the frequency to have an output frequency which is N times an input frequency, and the multiplier matches a desired harmonic frequency and filters out all the remaining frequencies. In addition, beamforming may be implemented by applying an array antenna or the like to the antenna of FIG. 15. In FIG. 15, IF denotes an intermediate frequency, a tripler and a multiplier denote a multiplier, PA denotes a power amplifier, LNA denotes a low noise amplifier, and PLL denotes a phase-locked loop.

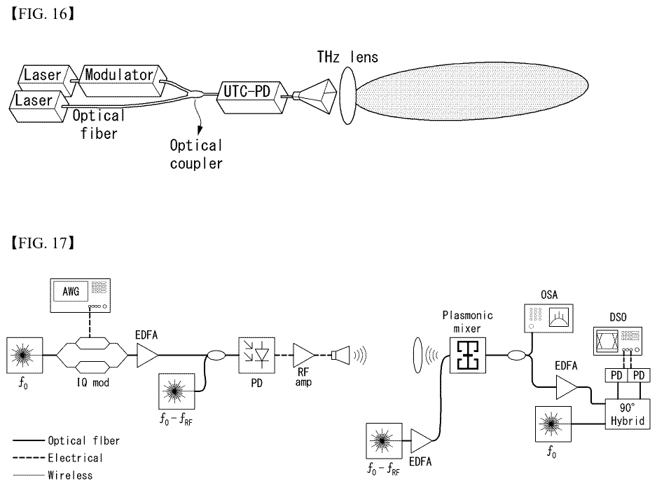

FIG. 16 illustrates an example of a method of generating an optical device-based THz signal.

FIG. 17 illustrates an example of an optical device-based THz wireless communication transceiver.

The optical device-based THz wireless communication technology refers to a method of generating and modulating a THz signal using an optical device. The optical device-based THz signal generation technology refers to a technology that generates an ultrahigh-speed optical signal using a laser and an optical modulator and converts it into a THz signal using an ultrahigh-speed photodetector. This technology is easy to increase the frequency compared to the technology using only the electronic device, can generate a high-power signal, and can obtain a flat response characteristic in a wide frequency band. In order to generate the optical device-based THz signal, as illustrated in FIG. 16, a laser diode, a broadband optical modulator, and an ultrahigh-speed photodetector are required. In FIG. 16, light signals of two lasers having different wavelengths are combined to generate a THz signal corresponding to difference in a wavelength between the lasers. In FIG. 16, an optical coupler refers to a semiconductor device that transmits an electrical signal using light waves to provide coupling with electrical isolation between circuits or systems, and a uni-travelling carrier photo-detector (UTC-PD) is one of photodetectors, which uses electrons as an active carrier and reduces the travel time of electrons by bandgap grading. The UTC-PD is capable of photodetection at 150 GHz or more. In FIG. 17, an erbium-doped fiber amplifier (EDFA) denotes an optical fiber amplifier to which erbium is added, a photo detector (PD) denotes a semiconductor device capable of converting an optical signal into an electrical signal, and OSA denotes an optical sub assembly in which various optical communication functions (e.g., photoelectric conversion, electrophotic conversion, etc.) are modularized as one component, and DSO denotes a digital storage oscilloscope.

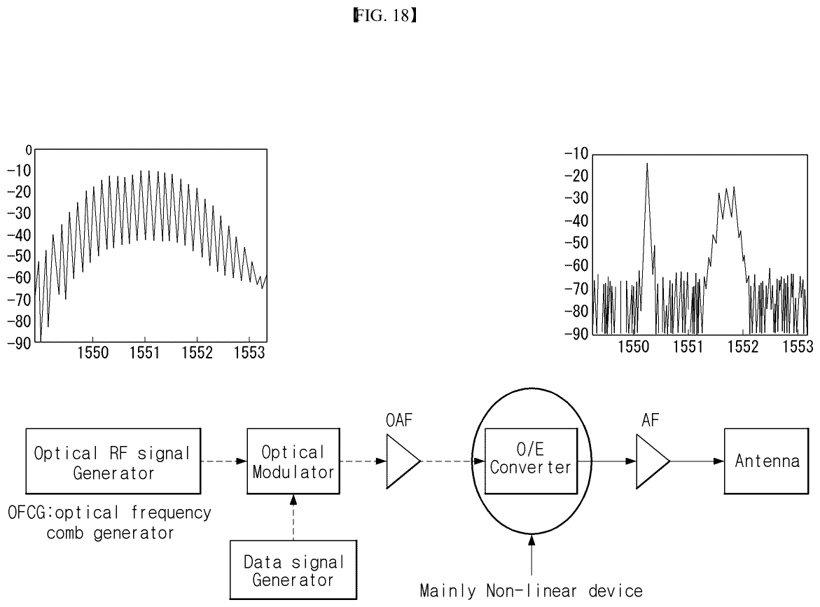

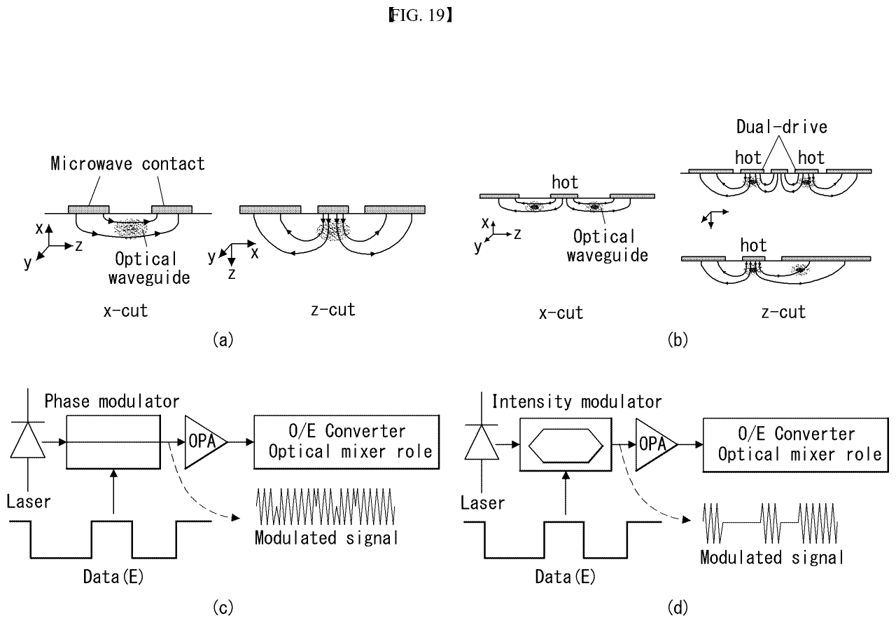

A structure of a photoelectric converter is described with reference to FIGS. 18 and 19.

FIG. 18 illustrates a structure of a photoinc source-based transmitter.

FIG. 19 illustrates a structure of an optical modulator.

Generally, an optical source of a laser may change a phase of a signal by passing through an optical wave guide. In this instance, data is carried by changing electrical characteristics through a microwave contact, or the like. Thus, an optical modulator output is formed in the form of a modulated waveform. A photoelectric modulator (O/E converter) may generate THz pulses based on an optical rectification operation by a nonlinear crystal, a photoelectric conversion (O/E conversion) by a photoconductive antenna, and emission from a bunch of relativistic electrons. The THz pulse generated in the above manner may have a length of a unit from femto second to pico second. The photoelectric converter (O/E converter) performs down-conversion using non-linearity of the device.

Considering THz spectrum usage, multiple contiguous GHz bands are likely to be used as fixed or mobile service usage for the terahertz system. According to outdoor scenario criteria, an available bandwidth may be classified based on oxygen attenuation 10\hat{ }2 dB/km in the spectrum of up to 1 THz. Hence, a framework in which the available bandwidth consists of several band chunks may be considered. As an example of the framework, if the length of the THz pulse for one carrier is set to 50 ps, the bandwidth (BW) is about 20 GHz.

The effective down-conversion from the infrared (IR) band to the THz band depends on how to utilize the nonlinearity of the photoelectric converter (O/E converter). That is, for down-conversion into a desired THz band, design of the photoelectric converter (O/E converter) having the most ideal non-linearity to move to the corresponding THz band is required. If a photoelectric converter (O/E converter) which is not suitable for a target frequency band is used, there is a high possibility that an error occurs with respect to an amplitude and a phase of the corresponding pulse.

In a single carrier system, a THz transmission/reception system may be implemented using one photoelectric converter. In a multi-carrier system, as many photoelectric converters as the number of carriers may be required, which may vary depending on the channel environment. Particularly, in a multi-carrier system using multiple broadbands according to the plan related to the above-described spectrum usage, the phenomenon will be prominent. In this regard, a frame structure for the multi-carrier system may be considered. A down-frequency-converted signal based on the photoelectric converter may be transmitted in a specific resource area (e.g., a specific frame). The frequency domain of the specific resource area may include a plurality of chunks. Each chunk may consist of at least one component carrier (CC).

### Detailed Description of Various Embodiments of the Present Disclosure

Hereinafter, various embodiments of the present disclosure will be described in more detail.

The present disclosure relates to a method of performing an entanglement error correction on bit flip, phase flip, and bit-phase flip errors generated by Pauli X, Y, and Z channels in a quantum communication system. More specifically, the present disclosure proposes a method of selectively performing an error correction process based on a dephasing time involved in a phase flip and a relaxation time involved in a bit flip and a bit-phase flip, in a process of correcting an entanglement error generated in an entanglement distribution process of quantum teleporation.

### Background Technology of Various Embodiments of the Present Disclosure

### 1. Bell State and Bell Basis

The Bell state is a simplest example of quantum entanglement and refers to the following four quantum states formed by two qubits in a maximally entangled state. This can be seen as the maximally entangled basis of the 4-dimensional Hilbert space for two qubits, and is referred to as Bell basis.

$$\vert {ϕ}^{+} 〉 = \frac{1}{\sqrt{2}} ( \vert {0}_{A} {0}_{B} 〉 + \vert {1}_{A} {1}_{B} 〉 ) \qquad [ Equation 1 ]$$

$$\vert {ϕ}^{-} 〉 = \frac{1}{\sqrt{2}} ( \vert {0}_{A} {0}_{B} 〉 - \vert {1}_{A} {1}_{B} 〉 )$$

$$\vert {ψ}^{+} 〉 = \frac{1}{\sqrt{2}} ( \vert {0}_{A} {1}_{B} 〉 + \vert {1}_{A} {0}_{B} 〉 )$$

$$\vert {ψ}^{-} 〉 = \frac{1}{\sqrt{2}} ( \vert {0}_{A} {1}_{B} 〉 - \vert {1}_{A} {0}_{B} 〉 )$$

2. Creation of Bell state

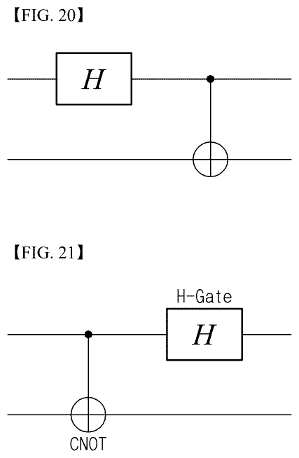

FIG. 20 illustrates an example of a quantum circuit for generating a Bell state in a system applicable to the present disclosure.

As illustrated in FIG. 20, the Bell state can be generated through a quantum circuit of two qubits consisting of a Hadamard gate and a CNOT gate (controlled not gate). Four two-qubit inputs |00 [symbol] , |01 [symbol] , |10 [symbol] , and |11 [symbol] have a Bell state output as shown in Table 3. Table 3 shows input and output states of a Bell state generation circuit.

TABLE 3

| Input (two-qubit) | Output (Bell state) |
|---|---|
| 00 | $\vert {ϕ}^{+} 〉 = \vert {B}_{00} 〉 = \frac{1}{\sqrt{2}} ( \vert {0}_{A} {0}_{B} 〉 + \vert {1}_{A} {1}_{B} 〉 )$ |
| 01 | $\vert {ψ}^{+} 〉 = \vert {B}_{01} 〉 = \frac{1}{\sqrt{2}} ( \vert {0}_{A} {1}_{B} 〉 + \vert {1}_{A} {0}_{B} 〉 )$ |
| 10 | $\vert {ϕ}^{-} 〉 = \vert {B}_{10} 〉 = \frac{1}{\sqrt{2}} ( \vert {0}_{A} {0}_{B} 〉 - \vert {1}_{A} {1}_{B} 〉 )$ |
| 11 | $\vert {ψ}^{-} 〉 = \vert {B}_{11} 〉 = \frac{1}{\sqrt{2}} ( \vert {0}_{A} {1}_{B} 〉 - \vert {1}_{A} {0}_{B} 〉 )$ |

### 3. Bell State Measurement/Bell State Analysis

FIG. 21 illustrates an example of a Bell state measurement circuit in a system applicable to the present disclosure.

As described above, since the Bell state forms a normal orthogonal basis, an appropriate measure can be defined to identify the four Bell states, and this is referred to as Bell state measurement or Bell state analysis. Bell state measurement means discovering the state of two qubits belongs to which of four quantum entanglement states defined by the Bell state. If the order of the CNOT gate and Hadamard gate in the Bell state generation circuit of FIG. 20 is reversed, the Bell state measurement circuit as shown in FIG. 21 is obtained. The measurement result shown in Table 4 can be obtained for the four quantum entanglement states corresponding to the Bell state. Table 4 shows input and output states of the Bell state measurement circuit.

TABLE 4

| Input (Bell state) | Output (two-qubit) |
|---|---|
| $\vert {ϕ}^{+} 〉 = \vert {B}_{00} 〉 = \frac{1}{\sqrt{2}} ( \vert {0}_{A} {0}_{B} 〉 + \vert {1}_{A} {1}_{B} 〉 )$ | 00 |
| $\vert {ψ}^{+} 〉 = \vert {B}_{01} 〉 = \frac{1}{\sqrt{2}} ( \vert {0}_{A} {1}_{B} 〉 + \vert {1}_{A} {0}_{B} 〉 )$ | 01 |
| $\vert {ϕ}^{-} 〉 = \vert {B}_{10} 〉 = \frac{1}{\sqrt{2}} ( \vert {0}_{A} {0}_{B} 〉 - \vert {1}_{A} {1}_{B} 〉 )$ | 10 |
| $\vert {ψ}^{-} 〉 = \vert {B}_{11} 〉 = \frac{1}{\sqrt{2}} ( \vert {0}_{A} {1}_{B} 〉 - \vert {1}_{A} {0}_{B} 〉 )$ | 11 |

### 4. Quantum Teleportation

Quantum teleportation is a technology that transmits quantum information from a sender at a specific location to a receiver at a certain distance. Contrary to the original meaning of the word ‘Teleport’, in quantum teleportation, carriers on both sides are fixed, and quantum information is transmitted between carriers rather than an actual carrier. For the instantaneous movement of such information, an entangled quantum state, that is, Bell state is required, and a statistical correlation is given between separate physical systems based on this. For every change that one of two entangled particles undergoes, the other particle also undergoes the same change, so the two particles behave as if they are in a single quantum state.

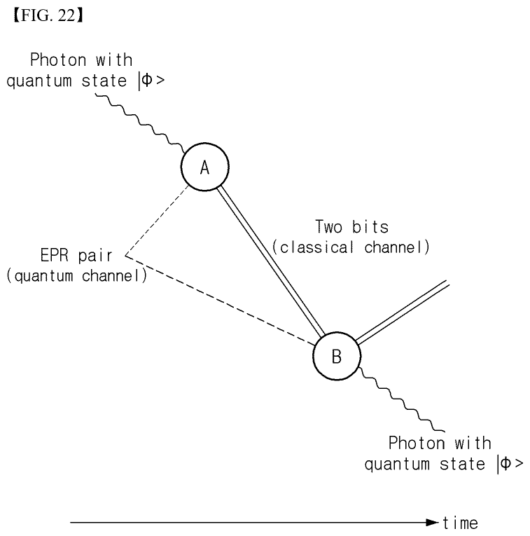

FIG. 22 illustrates an example of a quantum teleportation system in a system applicable to the present disclosure.

Specifically, FIG. 22 schematically illustrates a quantum teleportation protocol using photons. Quantum teleportation requires resources of a classical channel capable of transmitting two classical bits, a Bell state (entanglement state) generator, a quantum channel for moving two particles in the Bell state to transmitting and receiving ends of different locations, a Bell state measurement device at the transmitting end, and a unitary operation device at the receiving end. The operation of the protocol for the quantum information |φ [symbol] =α|0 [symbol] +β|1 [symbol] to be transmitted is as follows.
(1) Entanglement generation: An entanglement state of two qubits is generated through the Bell state generator.
(2) Entanglement distribution: The generated entanglement state moves one qubit to a location of a sender Alice (Alice, A) and the other qubit to a location of a receiver Bob (B) via a quantum channel.
(3) Quantum pre-processing: Alice performs a Bell state measurement on the quantum state |φ> she wants to transmit and one qubit of the Bell state she has, and obtains a result corresponding to one of the four Bell states. In this instance, the state of qubit, that Bob has, with respect to the Bell state measurement result of the Alice changes as shown in Table 5. Table 5 shows changes in the qubit of Bob's side according to the Bell state measurement result of the Alice' side.

TABLE 5

| BSM results of \|φ [symbol] and Alice's qubit | Bob's qubit |
|---|---|
| \|φ⁺ [symbol] | α\|0 [symbol] _{B} + β\|1 [symbol] _{B} |
| \|φ⁻ [symbol] | α\|0 [symbol] _{B} − β\|1 [symbol] _{B} |
| \|ψ⁺ [symbol] | α\|1 [symbol] _{B} + β\|0 [symbol] _{B} |
| \|ψ⁻ [symbol] | α\|1 [symbol] _{B} − β\|0 [symbol] _{B} |

(4) Classical transmission: Alice encodes the Bell state measurement result of the (3) into two classical bits and transmits them to Bob via the classical channel.
(5) Quantum post-processing): Based on the two bits of information received from Alice, Bob performs a unitary operation on the remaining one qubit of Bell state, that Bob has, to obtain the same quantum state as the quantum information |φ [symbol] that Alice wants to transmit.

### 5. Entanglement Generation and Distribution

Entanglement generation and distribution functions are key elements of quantum teleportation. Because Alice and Bob are nodes located at distant locations, entanglement generation that occurs at any one location must be complemented by an entanglement distribution function that “moves” one of the entangled particles to another. In this context, there is already a broad consensus in the relevant academic community on the adoption of photons as flying qubits, that is, entanglement carriers. Photons exhibit moderate decoherence characteristics due to their relatively small interaction with the environment, and have the advantage of not only enabling high-speed, low-loss transmission but also being easily controlled through standard optical components.

FIG. 23 illustrates an example of spontaneous parametric down-conversion in a system applicable to the present disclosure.

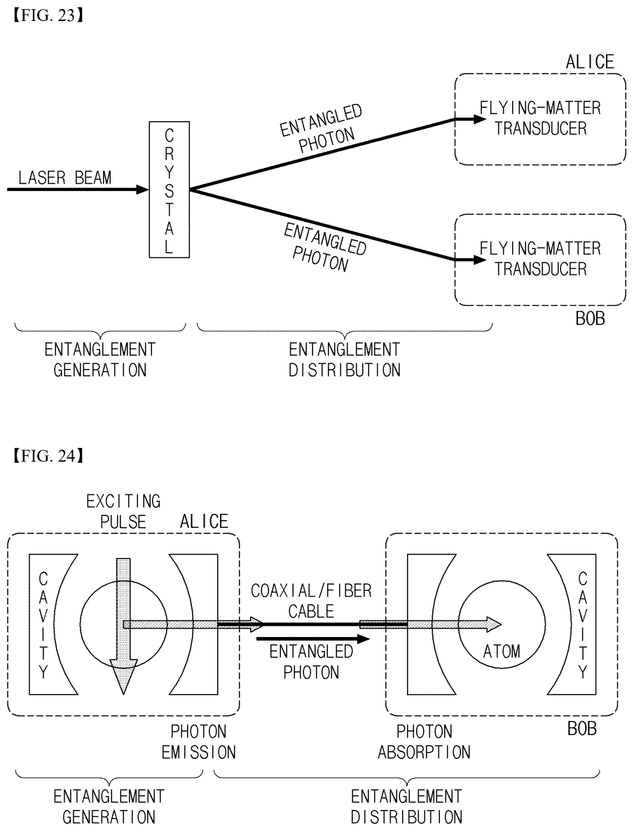

FIG. 24 illustrates an example of an atom excitation method in an optical cavity using a laser pulse in a system applicable to the present disclosure.

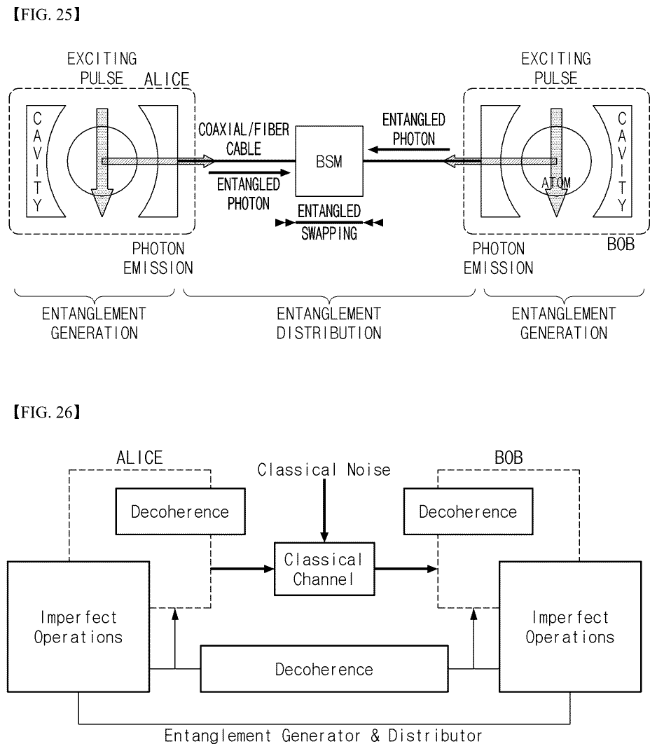

FIG. 25 illustrates an example of a method of simultaneous excitation of two atoms using a laser pulse in a system applicable to the present disclosure.

FIGS. 23 to 25 illustrate a practical design method for entanglement generation and distribution. A spontaneous parametric down-conversion method of FIG. 23 utilizes characteristics that, when a laser beam is projected onto a nonlinear crystal, photon beams are sometimes split into polarization entangled photon pairs. Using the method, since an entanglement pair between photons is generated, Alice and Bob convert each of photons received by Alice and Bob into a matter qubit using a flying-matter transducer.

In FIG. 24, Alice's side uses a laser pulse to excite atoms in an optical cavity, and as a result the emitted photons are incident on an optical cavity of Bob's side through the quantum channel, thereby representing how entanglement is formed between two remote atoms. In this method, it can be seen that entanglement between atoms and photons is first generated and then converted to entanglement between the atoms by means of the photons.

FIG. 25 illustrates that when Alice and Bob each use a laser pulse to simultaneously excite atoms in their optical cavity, the results show how entanglement is formed between two atoms by performing Bell state measurements at a third node, which can be referred to as a repeater, for two photons emitted from both sides. Using entanglement swapping, it can be seen that the entanglement between atoms and photons has been converted to entanglement between atoms.

From a perspective of where entanglement is generated, there is a difference in that entanglement is generated at the midpoint in FIG. 23, at the transmitting end in FIG. 24, and at both sides in FIG. 25. However, there is something in common in that all the three methods require a quantum channel because an entanglement state is transmitted through photons, which are flying qubits, and also the final form of entanglement distributed is the form of entanglement between atoms, that is, the form of entanglement between matter qubits that facilitate information processing and storage.

### 6. Incompleteness Involved in Quantum Teleportation Process

FIG. 26 illustrates an example of incompleteness that deteriorates the quantum teleportation process in a system applicable to the present disclosure.

Similar to classical communication, quantum communication processes can also be affected by the quality of information transmitted due to incompleteness that exist in the real world. FIG. 26 expresses the quantum teleportation process in an ideal environment as a closed physical system, but since the actual quantum teleportation process is affected by unwanted interactions with the surrounding environment, it shall be expressed as an open physical system. This interaction with the environment causes an irreversible change process in the quantum state, which is referred to a decoherence process. This decoherence process affects not only the unknown quantum state transfer process but also the entanglement generation and distribution process that must precede quantum teleportation. Another source of incompleteness involved in the quantum teleportation process is a series of quantum operations performed on the quantum state. Contamination in the quantum operation process becomes a factor that worsens the incompleteness of quantum teleportation.

FIG. 26 schematizes relationship between various incompleteness that affect the fidelity of qubits transmitted through quantum teleportation. Regardless of a specific cause of performance degradation, the incompleteness inherent in the quantum system results in a change from a pure quantum state to a mixed quantum state. Dealing with these quantum incompleteness is one of the key challenges in the field of quantum information science, but even today, incompleteness modeling in the quantum domain to accurately capture the effects of various incompleteness involved in the quantum teleportation process remains an open problem.

### 7. Quantum Decoherence and Quantum Channel Model

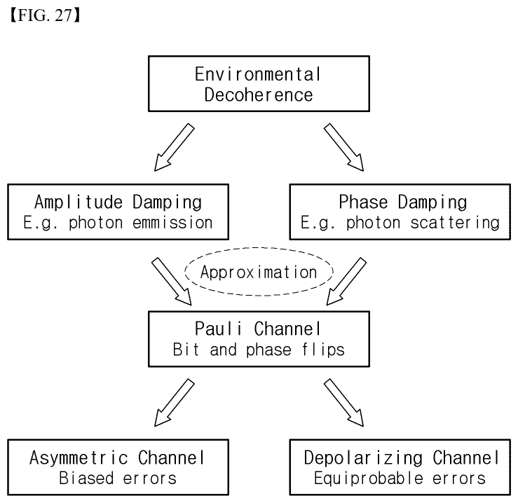

FIG. 27 illustrates an example of a quantum channel model in a system applicable to the present disclosure.

As described above, environmental decoherence constitutes a major cause of quantum state corruption, which can occur not only in quantum memory but also during quantum transfer or quantum processing. FIG. 27 illustrates a relationship between quantum channel models widely used in modeling of environmental decoherence.

Environmental decoherence can be described as an unwanted interaction of a qubit and an environment, more specifically entanglement, which disturbs coherent superposition of a fundamental quantum state. As an example, in this case, a qubit (or quantum system) loses energy due to an interaction with an environment, and it is conceivable that an excited state of the qubit collapses due to spontaneous emission of photons, or photons may be lost or absorbed during transmission of the photons through an optical fiber. This type of decoherence process may be modeled through an amplitude damping channel. Another example of environmental decoherence is a model known as dephasing or phase damping, which is characterized by loss of quantum information without loss of energy, which can occur, for example, in case of photon scattering or perturbation of electronic states due to stray charges.

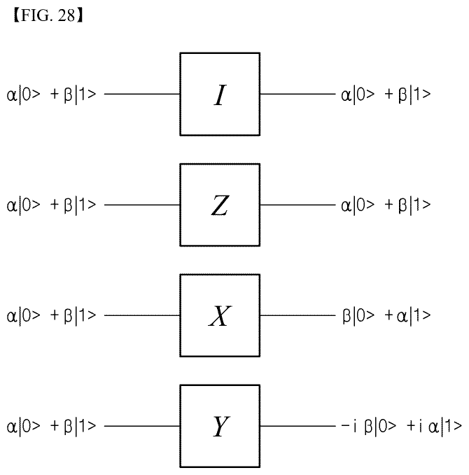

FIG. 28 illustrates an example of Pauli-I, Pauli-Z, Pauli-X, and Pauli-Y gates in a system applicable to the present disclosure.

However, since an amplitude attenuation channel or a phase attenuation channel model allows a result system for a N qubit system to have a 2^{N}-dimensional Hilbert space, it is not feasible to classically simulate these channels. For efficient classical simulations, amplitude and phase attenuation channels may be approximated by the Pauli channel Nₚ, which maps an input state with density operator ρ to a state shown in Equation 3 below.

$${N}_{P} ( ρ ) = ( 1 - {p}_{z} - {p}_{x} - {p}_{y} ) I ρ I + {p}_{z} Z ρ Z + {p}_{x} X ρ X + {p}_{y} Y ρ Y \qquad [ Equation 2 ]$$

In this instance, I, X, Y, and Z correspond to a single qubit Pauli operator in FIG. 28, and pₓ, p_{y}, and p_{z} are the probabilities of occurrence of Pauli X, Pauli Y, and Pauli Z errors. A bit flip error corresponding to the Pauli X channel and a bit-phase flip error corresponding to the Pauli Y channel are related to amplitude attenuation, and a phase flip error corresponding to the Pauli Z channel is caused by phase attenuation. In the most practical quantum system, an asymmetric channel is a channel in which one of bit flip, phase flip, or bit-phase flip errors dominantly occurs. The Pauli channel in a special case in which the bit flip error, the phase flip error, and the bit-phase flip error occur with equal probability (pₓ=p_{y}=p_{z}) is referred to as a depolarizing channel and can be mathematically expressed as in Equation 3 below.

$${N}_{DP} ( ρ ) = ( 1 - p ) I ρ I + \frac{p}{3} ( Z ρ Z + X ρ X + Y ρ Y ) \qquad [ Equation 3 ]$$

### 8. Quantum Error Correction Scheme

FIG. 29 illustrates an example of an error correction circuit for a 3-qubit bit flip code in a system applicable to the present disclosure.

3-qubit Bit Flip Error Code

A 3-qubit bit flip code is a quantum error correction code that can protect information from a single bit flip error occurring in the Pauli X channel. The structure of the 3-qubit bit flip code has a similar shape to a repetition code among the existing error correction codes. The 3-qubit bit flip code encodes one 1-qubit information into a space consisting of 3-qubits, and the encoding process is shown in Equation 4 below.

$$\vert 0 〉 \to \vert 000 〉 , \vert 1 〉 \to \vert 111 〉 \qquad [ Equation 4 ]$$

Therefore, any 1-qubit|φ [symbol] =α|0 [symbol] +b|1 [symbol] Q becomes |Ψ [symbol] =α|000 [symbol] +b|111 [symbol] through the encoding process. A codeword encoded by the 3-qubit bit flip code is transmitted to a receiver in one of the four cases in Equation 5 below, depending on a location where the error occurs during transmission to the receiver through a single bit flip error channel.

$$\vert {ψ}_{0} 〉 = a \vert 000 〉 + b \vert 111 〉 \qquad [ Equation 5 ]$$

$$\vert {ψ}_{1} 〉 = a \vert 100 〉 + b \vert 011 〉$$

$$\vert {ψ}_{2} 〉 = a \vert 010 〉 + b \vert 101 〉$$

$$\vert {ψ}_{3} 〉 = a \vert 001 〉 + b \vert 110 〉$$

In this instance, |Ψ₀ [symbol] represents that there occurs no error in the channel, and |Ψ₁ [symbol] , |Ψ₂ [symbol] , and |Ψ₃ [symbol] represent that a bit flip error occurs in first, second and third qubits, respectively. The decoding process of the 3-qubit bit flip code is performed through a projection operator. Codewords transmitted through the error channel become vectors that exist in subspaces orthogonal to each other depending on a location where the error occurs. Therefore, by projecting the transmitted information into the subspaces orthogonal to each other, the presence or absence of an error and a location at which the error occurs can be checked.

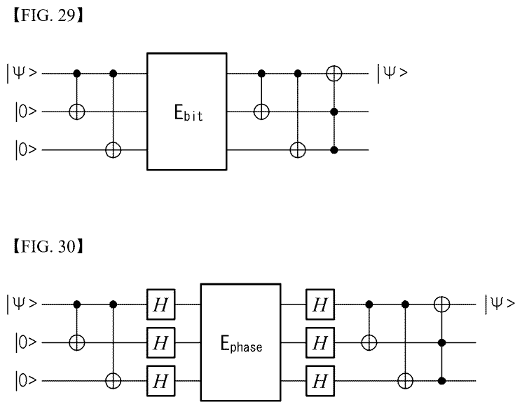

FIG. 30 illustrates an example of an error correction circuit for a 3-qubit phase flip code in a system applicable to the present disclosure.

3-qubit Phase Flip Error Code

A 3-qubit phase flip code is a quantum error correction code scheme that protects information from a single phase flip error occurring in the Pauli Z channel. The configuration of the 3-qubit phase flip code is similar to the 3-qubit bit flip code. A codeword of the 3-qubit phase flip code exists in a space consisting of |+++ [symbol] and |−−− [symbol] , where |+ [symbol] and |− [symbol] respectively represents states shown in Equation 6 below.

$$\vert + 〉 = \frac{1}{\sqrt{2}} ( \vert 0 〉 + \vert 1 〉 ) , \vert - 〉 = \frac{1}{\sqrt{2}} ( \vert 0 〉 - \vert 1 〉 ) \qquad [ Equation 6 ]$$

Therefore, any 1-qubit state is encoded as |Ψ [symbol] =α|+++ [symbol] +b|−−− [symbol] by a 3-qubit phase flip code. The |+ [symbol] state and the |− [symbol] state have a relationship where they are flipped to each other by the Z operator. This is similar to |0 [symbol] and |1 [symbol] being flipped to each other by the X operator.

FIG. 31 illustrates an example of a Shor code error correction circuit in a system applicable to the present disclosure.

### Shor Code

An encoding process of a Shor code is performed by performing the encoding process of the 3-qubit phase flip code and then applying the 3-qubit bit flip process to each qubit. A decoding process of the Shor code individually determines a bit flip error and a phase flip error occurring in the channel and corrects each error to thereby correct the overall error.

### Quantum Internet

A quantum Internet may be a broader network that includes both bits and qubits and may connect both information represented as bits and information represented as qubits. Based on the concept of quantum internet that links bits and qubits, quantum information processing may be understood as follows.
1) Quantum computing may be understood as a process of storing information of bits in qubits, converting a qubit state according to the laws of quantum physics, and then obtaining the bits from the qubits through measurement.
2) Quantum teleportation is a process of transferring a state of a qubit to another qubit.
3) Quantum memory is a process of storing a qubit state and restoring the same qubit state.
4) Quantum key distribution generates bits, stores the generated bits in the qubits, transmits the bits, and then reconstructs the bits again through measurement. The quantum key distribution secures informational security based on a fact that if a state included in the qubit is attacked by an eavesdropper, errors in the information shared between a transmitter and a receiver will increase.

In a quantum Internet environment, cloud quantum computing services may be used as follows. A user designs a quantum circuit and transmits the designed quantum circuit to a cloud quantum computing service. Here, the transmitted quantum circuit is described by using the information of the bit. The cloud quantum computing service implements quantum dynamics by a scheme in which the transmitted quantum circuit corresponds to the qubit. Thereafter, the cloud quantum computing service collects information expressed as bits through measurement of the qubits, and transmits the collected information to the user. The user receives a collected measurement result, and interprets the received measurement result.

The quantum Internet may link together distant cloud quantum computers. If one uses two cloud quantum computing services, the qubits included in the quantum computers are linked to each other through bits that describe the user. If physical qubits of two cloud quantum computing services share entanglement with each other or apply teleportation to the states of the qubits, the two quantum computers may be linked through the qubits to perform distributed quantum computing.

Quantum computers based on noisy intermediate scale quantum (NISQ) technology contain noise from each other, but the quantum computers may be linked through the quantum Internet to handle qubits included in a larger number and utilize the handled qubits for information processing. The quantum Internet may further enhance a capability of the NISQ technology. A core technology that enables the quantum Internet may be linking qubits that are far apart from each other with each other. For example, atoms may be used as qubits that are stationary in one location, and photons may be used to link qubits.

### Quantum Network

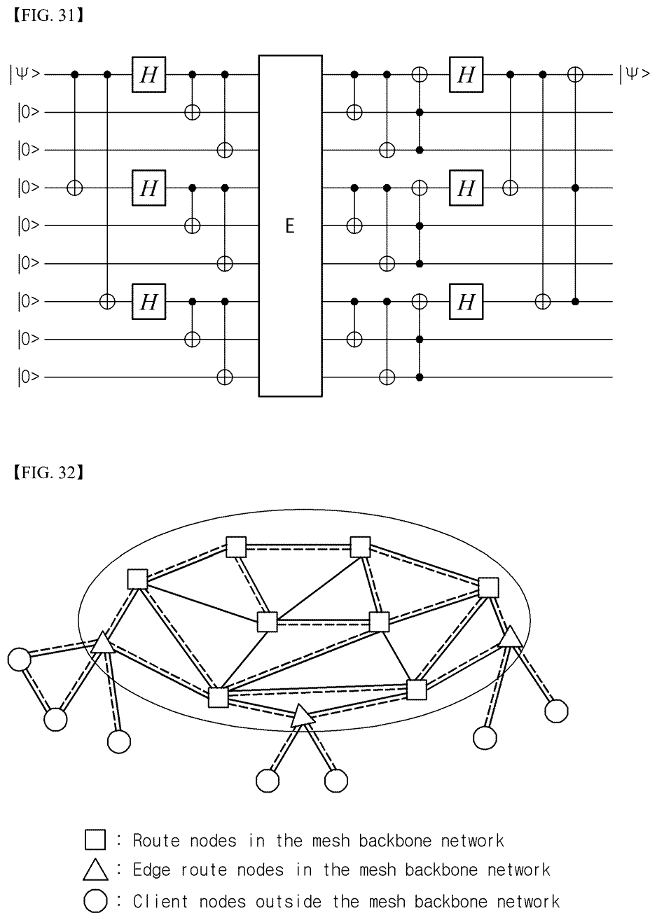

FIG. 32 illustrates an example of a quantum communication network model in a system applicable to the present disclosure.

In the future, long-distance transmission of quantum information through quantum networks will emerge as an important research field. The need for multi-hop quantum teleportation research is emerging to transmit quantum information between two distant nodes. A quantum channel may be constructed through entanglement shared by two contiguous nodes, and intermediate nodes, such as repeaters or trusted nodes, are introduced to transmit quantum information between nodes that do not directly share entanglement. FIG. 32 illustrates a quantum network model constructed based on a mesh structure. The quantum network model includes three types of nodes including a router (square), an edge router (triangle), and a client (circle), and two contiguous nodes are connected via classical channels (solid lines) and quantum channels (dashed lines).

In such a quantum network environment, since a direct quantum channel through which entanglement can be shared through direct transmission is not formed between any source node and destination node, technologies for multi-hop quantum information transmission are required. There are two major approaches to studies related to such multi-hop quantum information transmission. The first approach is a multi-hop quantum teleportation scheme that performs quantum teleportation on a hop-by-hop basis, similar to routing in classical communication so that information is transmitted to the destination node through hop-by-hop transmission. Another approach is a multi-hop entanglement swapping scheme that first forms entanglement to be used for information transmission between a source node and a destination node by performing multiple entanglement swappings on multi-hop links, and then performs quantum teleportation using the entanglement so that actual data can be transmitted to the destination node without directly traveling all multi-hop paths.

In order to perform multi-hop quantum teleportation or multi-hop entanglement swapping, an algorithm is needed to find a shortest path with a highest success rate among multiple multi-hop paths connecting a source node and a destination node. If routing in classical communication used an algorithm that finds a shortest path from a perspective of minimizing a transmission delay by considering a bandwidth of each link and a distance to a destination node because data transmission through a multi-hop path is performed hop by hop, multi-hop quantum teleportation or multi-hop entanglement swapping in quantum networks simultaneously involves quantum channel transmission or Bell state measurement, or the like at each hop constituting a multi-hop path. Therefore, for successful transmission, there is no transmission delay based on a length of the path or the number of hops. However, when any multi-hop path is selected, the success of the quantum teleportation or entanglement swapping process for the entire path is characterized in being determined probabilistically based on a success rate of the entanglement distribution and Bell state measurement performed at each hop. Therefore, a shortest path algorithm and a quantum resource allocation rate enhancement scheme are required from a perspective of maximizing the success rate of the quantum teleportation or entanglement swapping process for the entire path by considering the characteristics described above.

### Configuration of Various Embodiments of the Present Disclosure

The present disclosure proposes a quantum resource allocation (QRA) scheme that provides an improved quantum resource allocation (QRA) rate by searching for an optimal path between any two source and destination nodes connected through a multi-hop path in a quantum network and selecting multiple optimal disjoint paths. The present disclosure proposes an optimal path search algorithm that considers an entanglement distribution success rate and a Bell state measurement success rate of each hop based on unique properties of a quantum network that were not considered in the routing of a classical network. Each node can repeatedly perform the optimal path search algorithm using a network topology graph, a source node, and a destination node as inputs to derive multiple optimal disjoint paths and can improve a quantum resource allocation rate based on this. The number of optimal paths involved in quantum resource allocation may be determined based on quantum resource allocation rate requirements, maximum channel usage, etc. included in the corresponding QRA request, and through this, the network resource efficiency and the fairness of resource utilization between nodes may be considered in a quantum resource allocation process.

The quantum resource allocation method proposed in the present disclosure can be applied to a quantum communication network as illustrated in FIG. 13. Each node may be connected to contiguous nodes through a classical channel and a quantum channel, and each node may share its network topology information with other nodes of the network and continuously update it. The network topology information may include information on the quantum network including an entanglement distribution success rate through a direct quantum channel of each link, a Bell state measurement success rate of each node, etc., and the exchange and update of the network topology information may be performed through the classical channel. Each node in the network may obtain an entire network graph based on network topology information received from other nodes, and may manage it as a network topology database (NTDB). Signaling or timer operation, etc. may be applied to maintain the freshness of the network topology information shared by each node.

The quantum resource allocation scheme proposed in the present disclosure may be based on deriving the multiple optimal disjoint paths between the source node and the destination node, and the disjoint path may correspond to either a link-disjoint path or a link & node-disjoint path. In the present disclosure, a path between any source and destination nodes may be expressed as a set of link elements and a set of node elements constituting the path. The link-disjoint path refers to a case where there may be an intersection between sets of node elements constituting each path for any two or more paths, but there may be no intersection between the sets of link elements constituting the path. The link & node-disjoint path refers to a case where there is no intersection both between sets of link elements constituting each path and between sets of node elements constituting each path for any two or more paths. The link-disjoint path may be used when it is desired to avoid a case where resource allocation through the multiple paths fails due to a common link error. The link & node-disjoint path may be used when it is desired to avoid a case where resource allocation through the multiple paths fails due to a common node error as well as the common link error.

The quantum resource allocation scheme proposed in the present disclosure may simultaneously perform multi-hop entanglement swapping through the derived multiple optimal paths. Nodes of the quantum network included in the multiple optimal paths share entanglement with contiguous nodes on the optimal path at the promised same time, store it in a quantum memory, and perform Bell state measurement between determined quantum memory pairs on the derived optimal path, thereby enabling the multi-hop entanglement swapping to be performed on the optimal path in which the nodes are included. Through this, the effect of increasing a quantum resource allocation rate through multiple optimal paths can be obtained compared to the quantum resource allocation scheme based on a single optimal path.

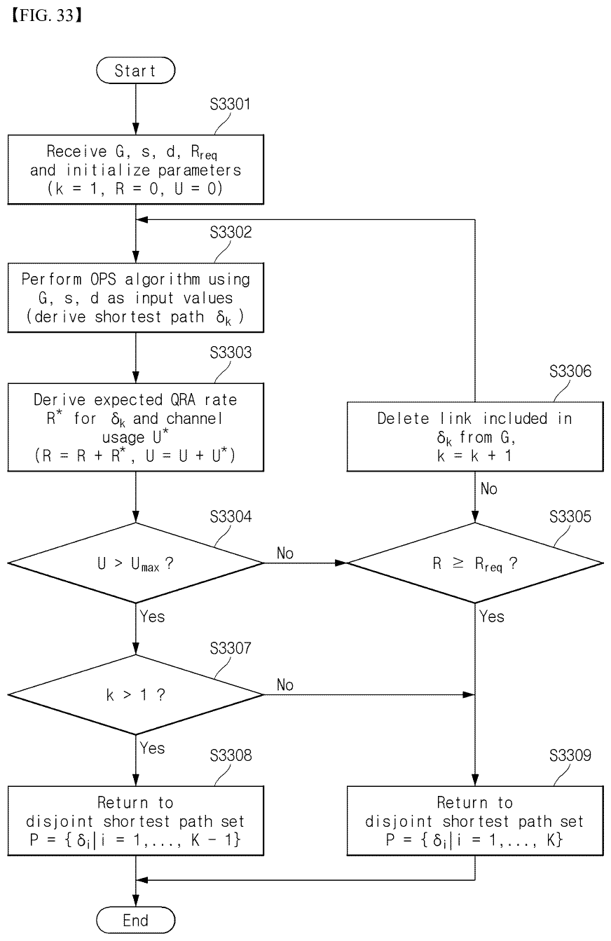

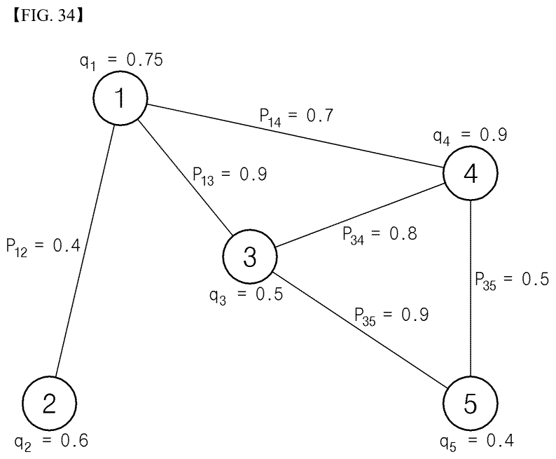

FIG. 33 illustrates an example of a detailed procedure of a process of deriving multiple optimal paths in a system applicable to the present disclosure.

Detailed processes of a procedure of deriving multiple optimal paths proposed in the present disclosure are as follows.
(1) QRA initialization step (step S3301)
(1-1) Receive an NTDB based network graph G, source node ID s, destination node ID d, and required QRA rate R_{req}.
(1-2) QRA parameter initialization: k=1, R=0, U=0
(2) k-th round optimal path search (OPS) step (step S3302)
(2-1) Perform an OPS algorithm using G, s, d received in the step (1) as input values to obtain k-th optimal path δₖ

$${δ}_{k} = ( {V}_{k} , {L}_{k} ) \qquad [ Equation 7 ]$$

$${V}_{k} = \{ v \vert v is a node constituting {δ}_{k} , v \neq s , v \neq d \}$$

$${L}_{k} = \{ l \vert l is a direct quantum channel link node constituting {δ}_{k} \}$$

(3) Step of updating an expected value of a quantum resource allocation rate for k-th round and a channel usage
(3-1) Step of deriving an expected value R* of a quantum resource allocation rate for δₖ and a channel usage U* (step S3303)

$${R}^{*} = {\prod }_{l ∈ {L}_{k}} {p}_{l} {\prod }_{v ∈ {V}_{k}} {p}_{v} , {U}^{*} = {\sum }_{l ∈ {L}_{k}} {p}_{l} \qquad [ Equation 8 ]$$

(3-1-1) pr: entanglement distribution success rate of link l
(3-1-2) qᵥ: Bell state measurement success rate of node v
(3-2) Step of deriving an expected value of total quantum resource allocation rate and the total channel usage achieved through all paths (δ₁, δ₂, . . . , δₖ) acquired so far (step S3303)
(3-2-1) The expected value of the total resource allocation rate and the total channel usage can be obtained by respectively adding R* and U* to the expected value of the resource allocation rate and the channel usage when using (δ₁, δ₂, . . . , δₖ₋₁) (R←R+R*, U←U+U*)
(3-2-2) If the total channel usage is to be considered only by the number of direct links used without considering the quality of each channel, it can be calculated by the number of direct quantum channel link elements included in δ₁, δ₂, . . . , δₖ (U=|L₁∪ . . . ∪Lₖ|)
(4) Step of checking whether it exceeds maximum channel usage Uₘₐₓ (step S3304)
(4-1) If U>Uₘₐₓ: when k>1 (step S3307) P={δᵢ|i=1, . . . , k−1} (step S3308), and when k=1 return to P={δ₁} (step S3309) and end the process
(4-2) If U≤Uₘₐₓ: proceed to step (5) (step S3305)
(5) Step of checking whether the required QRA rate R_{req} is achieved (step S3305)
(5-1) If R<R_{req}: delete Lₖ from G, update it to k←k+1 (step S3306), and proceed to step (2) (step S3302)
(5-2) If R≥R_{req}: return to P={δᵢ|i=1, . . . , k} (step S3309) and end the process

The step (2) (step S3302) of deriving the multiple optimal path proposed in the embodiment of FIG. 33 is performed based on an optimal path search (OPS) algorithm that relies on the unique properties of quantum networks. The OPS algorithm proposed in the present disclosure searches for an optimal path between a given source node and a given destination node, considering an entanglement distribution success rate and a Bell state measurement success rate of each hop. The OPS algorithm proposed in the present disclosure starts from the source node and adds all nodes that can be visited via direct links from a location of a node being currently visited in each round to an open list. And, if a node to be added to the open list has already been added to the open list, it is updated to current visit information only if a weight of the path through a currently visited node is greater than a weight of a path in the existing list. If the node being currently visited and all the nodes that can be visited via the direct links have been added to the open list, the visit to the current node is considered complete and information of the current node is moved to the closed list. Subsequently, a node with the largest weight for the optimal path from the source node among the nodes stored in the open list is selected as a destination for a next round. The OPS algorithm finds the optimal path between a given source node and a given destination node by repeating the round until the destination node is moved to the closed list.

A detailed procedure of the OPS algorithm proposed in the present disclosure is as follows.
(1) Algorithm initialization step
(1-1) Add a source node to an open list to input optimal path information including a distance weight W_{d}, a repeater weight Wᵣ, and a parent node.
(1-1-1) Since the optimal path information of the source node is a path from itself to itself, W_{d}=1, Wᵣ=1, and parent node=source node.
(2) First visit (visit to source node) step
(2-1) Since only the source node is stored in the open list, select the source node as a destination for a first round.
(2-2) Add nodes connected to the source node via direct links to the open list, and record the parent node and W_{d} and Wᵣ values as optimal path information for the nodes from the source node.
(2-3) Input a source node ID to the parent node, and input W_{d} as an entanglement distribution success rate pᵢⱼ for the direct link with the source node and input Wᵣ as the product of W_{d} and a Bell state measurement success rate q of the corresponding node (Wᵣ=W_{d}×q).
(2-4) Move the source node to a closed list.
(3) Path search step
(3-1) Select a node with the largest Wᵣ among the nodes in the open list as the destination for this round.
(3-2) Add remaining nodes, that excludes the node stored in the closed list from nodes connected to a currently visited node via the direct link, to the open list and record optimal path information. Also, nodes that has been already added to the open list in a previous round, update only the optimal path information.
(3-2-1) W_{d}: Product of W_{d} of the parent node and the entanglement distribution success rate pᵢⱼ for the direct link with the parent node
(3-2-1-1) Update the node that has been already added to the open list only if W_{d} value of a path through a new parent node is greater than the existing W_{d} value
(3-2-2) Wᵣ=W_{d}×q (but if a destination node is added to the open list, Wᵣ=W_{d})
(3-3) Move the currently visited node to the closed list.
(3-4) Repeat the process of (3) until the destination node is selected as a next visited node, and if the destination node is selected as the visited node, move the destination node to the closed list without adding or updating a new node in the open list and end the path search (go to step of obtaining an optimal path).
(4) Step of obtaining an optimal path
(4-1) If the destination node moves to the closed list, a node corresponding to the parent node of the destination node is found in the closed list, and the process of finding the parent node of the corresponding node is repeated until reaching the source node, thereby obtaining optimal path information and ending the algorithm.

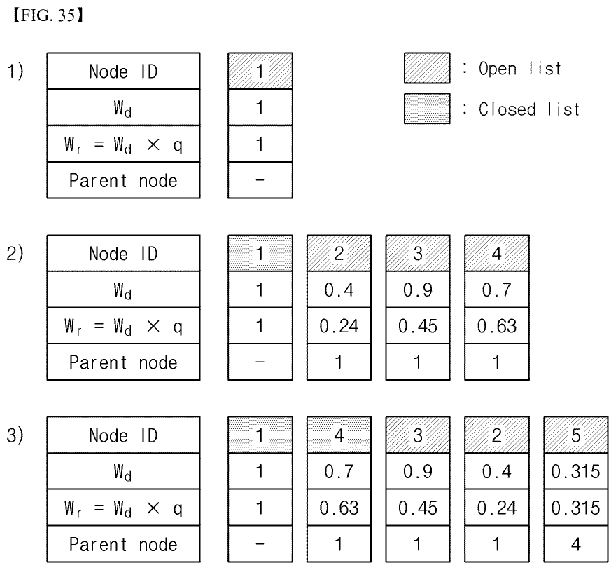

FIG. 34 illustrates an example of a quantum network including quantum nodes and quantum direct channel links in a system applicable to the present disclosure.

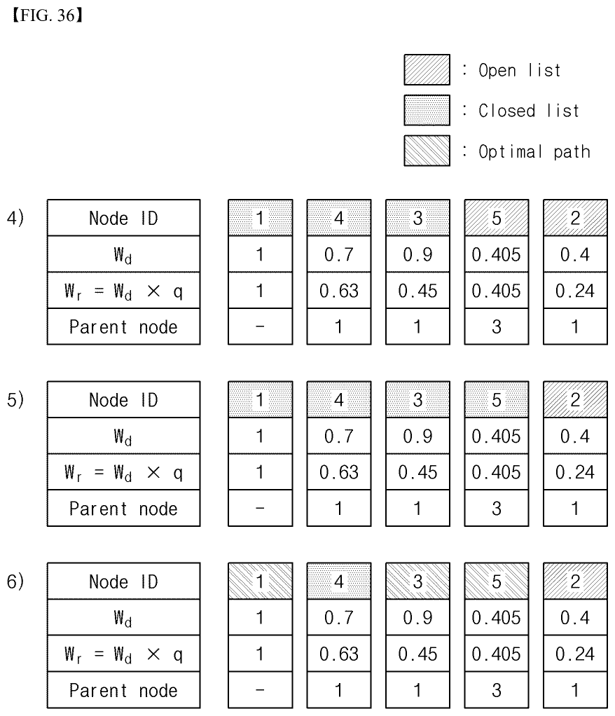

FIG. 34 illustrates an example of a quantum network including quantum nodes and quantum direct channel links. In the quantum network illustrated in FIG. 34, a process of searching for an optimal path using node 1 as a source node and node 5 as a destination node based on the OPS algorithm proposed in the present disclosure is described based on embodiments of FIGS. 35 and 36.

FIG. 35 illustrates an example of an optimal path search process (step (1) to step (3)) based on an OPS algorithm in a system applicable to the present disclosure.

FIG. 36 illustrates an example of an optimal path search process (step (4) to step (6)) based on an OPS algorithm in a system applicable to the present disclosure.

FIGS. 35 and 36 illustrates a process of searching for an optimal path from node 1 to node 5 for the network graph of FIG. 34 based on the OPS algorithm proposed in the present disclosure, through six steps. The more detailed operation of the algorithm at each step is as follows.
Step (1): Add the node 1 to the open list and input optimal path information (W_{d}=1, Wᵣ=1, and parent node=node 1)
Step (2): Perform an open list update for nodes 2, 3, and 4 that are directly linked to the node 1 using the node 1 as a visited node (store optimal path information with the node 1 as the parent node), and move the node 1 to the closed list.
Step (3): Select the node 4 with the largest Wᵣ value among the nodes 2, 3, and 4 in the open list as a next visited node, perform an open list update for the nodes 3 and 5, excluding the node 1, which is stored in the closed list, among the nodes 1, 3, and 5 that are directly linked to the node 4 (because the node 3 is already stored in the open list, and the W_{d} value when the currently visited node, the node 4, is the parent node is less than the existing W_{d} value, the optimal path information is not updated), and move the node 4 to the closed list.
Step (4): Select the node 3 with the largest Wy value among the nodes 2, 3, and 5 in the open list as a next visited node, perform an open list update for the node 5, excluding the nodes 1 and 4, which are stored in the closed list, among the nodes 1, 4, and 5 that are directly linked to the node 3 (because the node 5 is already stored in the open list, and the W_{d} value when the currently visited node, the node 3, is the parent node is greater than the existing W_{d} value, update relevant information to the optimal path with the node 3 as the parent node), and move the node 3 to the closed list.
Step (5): Select the node 5 with the largest Wᵣ value among the nodes 2 and 5 in the open list as a next visited node, and move the node 5 to the closed list without updating the open list since the corresponding node corresponds to the destination node.
Step (6): Obtain the optimal path (node 1→node 3→node 5) by backtracking parent node information until reaching from the destination node, the node 5, to the source node, the node 1.

FIG. 37 illustrates an example of a network structure for quantum resource allocation (S: source node, D: destination node, C: coordinator) in which the coordinator exists outside the network topology in a system applicable to the present disclosure.

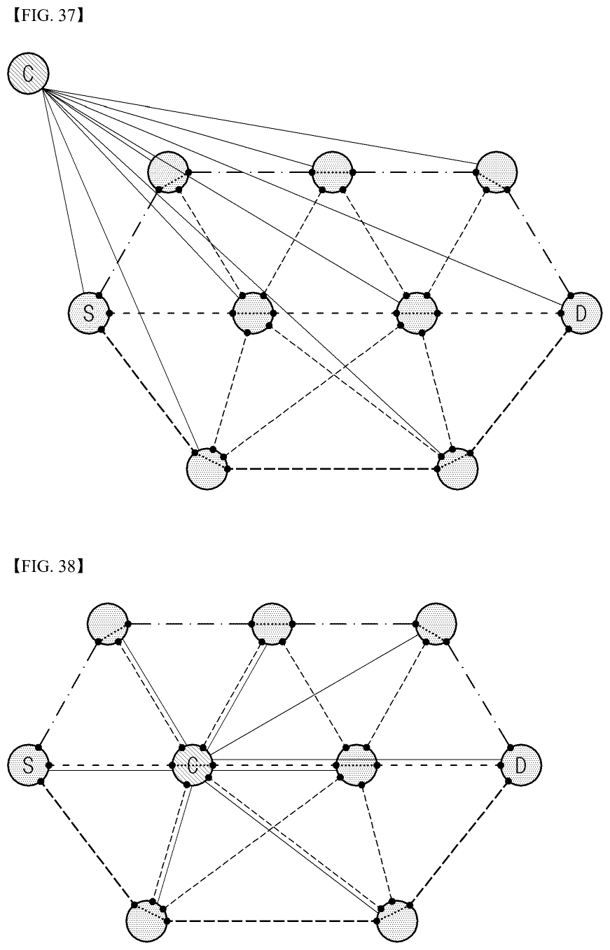

FIG. 38 illustrates an example of a network structure for quantum resource allocation (S: source node, D: destination node, C: coordinator) in which the coordinator exists within the network topology in a system applicable to the present disclosure.

The quantum resource allocation method based on the present disclosure requires a procedure of promising the same time resources so that nodes included in multiple optimal paths can simultaneously perform multi-hop entanglement swapping. This procedure may be performed by a coordinator of the network, and the coordinator role may be performed by one of the nodes included in the quantum network topology or performed by a separate node existing outside the quantum network topology. FIGS. 37 and 38 illustrate an example of a network structure based on the quantum resource allocation method proposed in the present disclosure. FIG. 37 illustrates an example of the network structure in which a node serving as the coordinator exists outside the network topology. FIG. 38 illustrates an example of the network structure in which one of nodes included in the network topology serves as the coordinator.

The quantum resource allocation process based on the present disclosure may be performed in a centralized or distributed manner depending on an entity performing the optimal path search algorithm when searching for multiple optimal disjoint paths.

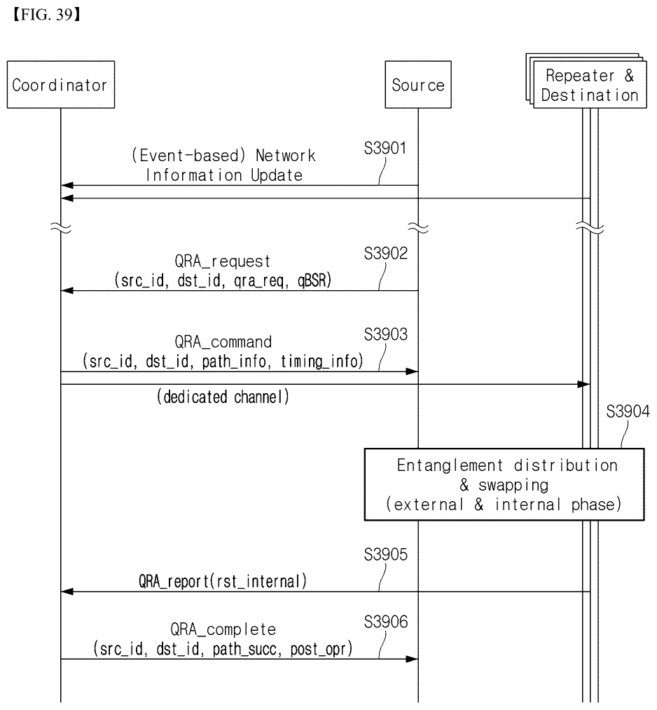

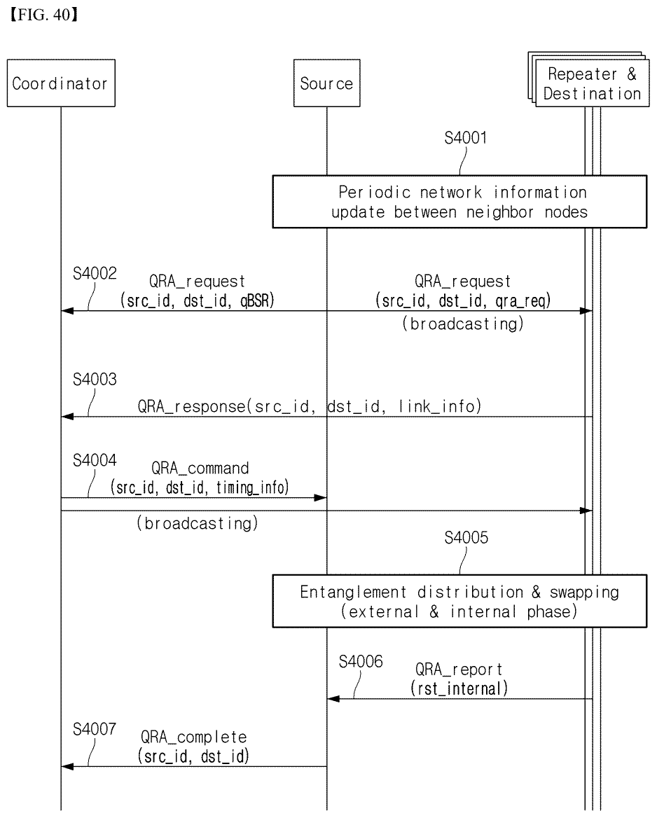

FIG. 39 illustrates an example of a quantum resource allocation process based on a centralized optimal path search in a system applicable to the present disclosure.

A centralized optimal path search method is a method in which a coordinator performs an optimal path search algorithm based on the flow as in an embodiment of FIG. 33 and transmits the result to nodes included in an optimal path along with timing information. A more detailed process of a quantum resource allocation method based on the centralized optimal path search is as follows.
(1) Step S3901: Network Topology Information (NTI) report
(1-1) Before the quantum resource allocation process is performed, all nodes in the network report their network topology information to a coordinator periodically or when an update occurs so that the network topology information held by the coordinator can be kept fresh.
(2) Step S3902: Quantum Resource Allocation (QRA) Request
(2-1) When a data transmission requiring quantum resources occurs, a source node transmits a QRA request message to a coordinator node.
(2-2) The QRA request message may include their own buffer status information (quantum buffer status report (qBSR)) and QRA requirement information (qra_req).
(3) Step S3903: QRA command
(3-1) When the QRA request message is received, the coordinator performs an optimal path search algorithm based on the collected network topology information.
(3-2) A QRA command message including information of the derived optimal path and timing information is transmitted to all nodes included in an optimal path including the source node and a destination node.
(3-3) The timing information included in the QRA command message may be determined based on the buffer status information and the QRA requirement information included in the QRA request message.
(4) Step S3904: Entanglement distribution & entanglement swapping
(4-1) Each node receiving the QRA command message performs entanglement distribution and entanglement swapping with the contiguous nodes on the optimal path, in which each node is included, based on the timing information included in the QRA command message.
(4-2) Entanglement distribution phase or external phase
(4-2-1) Perform a process of generating and distributing the entanglement between nodes connected through direct links on the optimal path.
(4-2-2) It is classified as an external phase in the sense that it is a process of forming external links with contiguous nodes among the components of a given optimal path.
(5) Step S3904: Entanglement swapping phase or Internal phase
(5-1) Each node included in the optimal path performs Bell state measurement between two quantum memories included in different external links to form an internal link for the two external links, i.e., perform the entanglement swapping.
(5-2) The Bell state measurement is performed only between the quantum memories where the external links have been successfully formed. If either of the two quantum memories fails to form the external link, it is considered that the Bell state measurement is not performed and fails.
(5-3) It is classified as an internal phase in the sense that it is a process of forming a link, i.e., an internal link between two quantum memories existing within each node among the components of a given optimal path.
(6) Step S3905: QRA report
(6-1) Each node reports a result of performing the entanglement distribution and the entanglement swapping to the coordinator.
(6-2) The QRA report message reports the state corresponding to the result of performing the Bell state measurement in the entanglement swapping phase among four Bell states if the entanglement swapping phase is successful, and reports information informing a failure if the entanglement distribution phase or the entanglement swapping phase fails.
(7) Step S3906: QRA complete
(7-1) The coordinator determines whether there is a path where multi-hop entanglement swapping among multiple optimal paths is successfully performed based on the QRA report message received from each node.
(7-2) If there is a path where the multi-hop entanglement swapping is successful, information on the path and necessary post-processing operation information are transmitted to the source node and the destination node.

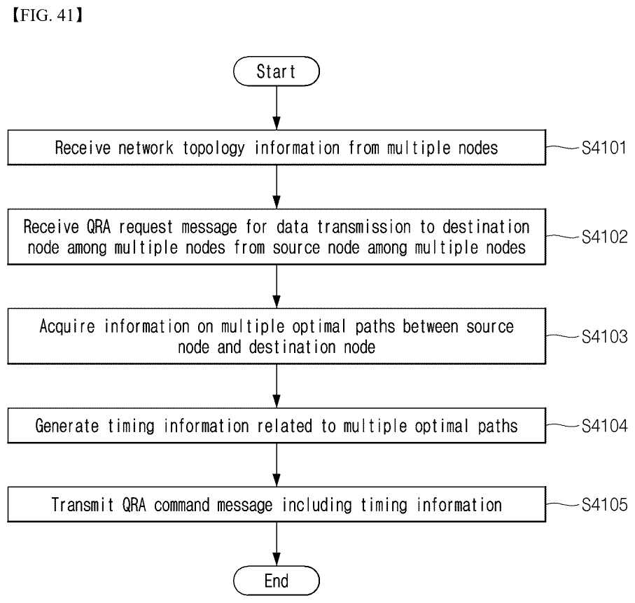

FIG. 40 illustrates an example of a quantum resource allocation process based on a distributed optimal path search in a system applicable to the present disclosure.

A distributed optimal path search method is a method in which each node in a network performs an optimal path search algorithm based on the flow as in an embodiment of FIG. 33, and if it is determined as a result that the node is included in an optimal path, the node participates in multi-hop entanglement swapping based on timing information transmitted by a coordinator. A more detailed process of a quantum resource allocation method based on the distributed optimal path search is as follows.
(1) Step S4001: Network Topology Information (NTI) update
(1-1) All nodes in the network perform a process of sharing their network topology information with all the nodes in the network periodically or when an update occurs so that the network topology information shared between all the nodes can be kept fresh.
(2) Step S4002: Quantum Resource Allocation (QRA) request
(2-1) When a data transmission requiring quantum resources occurs, a source node transmits a QRA request message to all the nodes in the network.
(2-2) The QRA request message may include their own buffer status information (quantum buffer status report (qBSR)) and QRA requirement information (qra_req).
(3) Step S4003: QRA response
(3-1) When the QRA request message is received, each node performs an optimal path search algorithm based on the network topology information held by each node.
(3-2) If it is determined that the node is included in an optimal path, the node transmits a QRA response message containing path information including the node to a coordinator.
(4) Step S4004: QRA command
(4-1) The coordinator determines timing information based on the QRA response message received from each node and transmits a QRA command message to all nodes participating in the QRA.
(4-2) The timing information included in the QRA command message may be determined based on the buffer status information and QRA requirement information included in the QRA request message.
(5) Step S4005: Entanglement Distribution & Entanglement Swapping
(5-1) Each node receiving the QRA command message performs entanglement distribution and entanglement swapping with the contiguous nodes on the optimal path, in which each node is included, based on the timing information included in the QRA command message.
(5-2) Entanglement distribution phase or external phase
(5-2-1) Perform a process of generating and distributing the entanglement between nodes connected through direct links on the optimal path.
(5-2-2) It is classified as an external phase in the sense that it is a process of forming external links with contiguous nodes among the components of a given optimal path.
(5-3) Entanglement swapping phase or internal phase
(5-3-1) Each node included in the optimal path performs Bell state measurement between two quantum memories included in different external links to form an internal link for the two external links, i.e., perform the entanglement swapping.
(5-3-2) The Bell state measurement is performed only between the quantum memories where the external links have been successfully formed. If either of the two quantum memories fails to form the external link, it is considered that the Bell state measurement is not performed and fails.
(5-3-3) It is classified as an internal phase in the sense that it is a process of forming a link, i.e., an internal link between two quantum memories existing within each node among the components of a given optimal path.
(6) Step S4006: QRA report
(6-1) Each node reports a result of performing the entanglement distribution and the entanglement swapping to the source node.
(6-2) The QRA report message reports the state corresponding to the result of performing the Bell state measurement in the entanglement swapping phase among four Bell states if the entanglement swapping phase is successful, and reports information informing a failure if the entanglement distribution phase or the entanglement swapping phase fails.
(7) Step S4007: QRA complete
(7-1) The source node determines whether there is a path among multiple optimal paths where multi-hop entanglement swapping is successfully performed based on the QRA report message received from each node.
(7-2) If there is a path where the multi-hop entanglement swapping is successful, a QRA complete message is transmitted to the coordinator.
(7-3) If there is no successful path or additional quantum resource allocation is required, a QRA re-request message is transmitted to the coordinator.

### Effect of Various Embodiments of the Present Disclosure

The expected effects for various embodiments of the present disclosure are as follows.

The present disclosure proposes a quantum resource allocation technique based on searching multiple optimal disjoint paths between any two source and destination nodes connected through multi-hop paths in a quantum network. The present disclosure proposes an optimal path search algorithm suitable for a quantum network by proposing an optimal path search algorithm that considers an entanglement distribution success rate and a Bell state measurement success rate of each hop based on unique properties of the quantum network that were not considered in the routing of a classical network.

The present disclosure can expect the effect of improving a quantum resource allocation rate and reducing a quantum resource allocation delay by searching multiple optimal paths, compared to the quantum resource allocation based on a single optimal path. In addition, the present disclosure can contribute to improving the network resource efficiency and the fairness of network resource utilization between nodes in the quantum resource allocation process by considering the quantum resource allocation rate requirement for the corresponding QRA request, maximum channel usage, etc. when determining the number of optimal paths to be input into the QRA request.

Characteristic configurations for various embodiments of the present disclosure are as follows.
(1) The present disclosure provides a method and procedure for allocating quantum resources between any two source and destination nodes connected through a multi-hop path in a quantum internet or a quantum communication network, including:
searching for multiple optimal disjoint paths considering an entanglement distribution success rate of each link and a bell state measurement success rate of each node; and
performing simultaneously parallel multi-hop entanglement swapping on the searched multiple optimal paths.

### Description of Claims Related to Coordinator Node (Centralized)

Below, the above-described embodiments are described in detail from an operation perspective for a coordinator node (centralized) with reference to FIG. 41. Methods to be described below are merely distinguished for convenience of explanation. Thus, as long as the methods are not mutually exclusive, it is obvious that partial configuration of any method can be substituted or combined with partial configuration of another method.

FIG. 41 illustrates an example of an operation process of a coordinator node (centralized) in a system applicable to the present disclosure.

According to various embodiments of the present disclosure, there is provided a method performed by a coordinator node in a communication system.

According to various embodiments of the present disclosure, each of multiple nodes including a source node and a destination node may correspond to one of a user equipment (UE) or a base station in a wireless communication system. According to various embodiments of the present disclosure, the coordinator node may correspond to one of a UE or a base station in the wireless communication system.

An embodiment of FIG. 41 may further include, before step S4101, a step in which the coordinator node transmits one or more synchronization signals to the multiple nodes; and a step in which the coordinator node transmits system information to the multiple nodes. The embodiment of FIG. 41 may further include, before the step S4101, a step in which the coordinator node receives a random access preamble from the multiple nodes; a step in which the coordinator node transmits a random access response (RAR) to the multiple nodes; a step in which the coordinator node receives a random access message 3 (message 3) from the multiple nodes; and a step in which the coordinator node transmits a contention resolution message to the multiple nodes. The message 3 is a first PUSCH transmission scheduled by a RAR together with an RAR UL grant. The embodiment of FIG. 41 may further include, before the step S4101, a step in which the coordinator node transmits control information to the multiple nodes.

In the step S4101, the coordinator node receives network topology information from the multiple nodes. The network topology information includes information on an entanglement distribution success rate of multiple links related to the multiple nodes, and information on a Bell state measurement (BSM) success rate of the multiple nodes.

In step S4102, the coordinator node receives, from a source node among the multiple nodes, a quantum resource allocation (QRA) request message for a data transmission to a destination node among the multiple nodes.

In step S4103, the coordinator node acquires information on multiple optimal paths between the source node and the destination node. The multiple optimal paths are determined based on the network topology information.

In step S4104, the coordinator node generates timing information related to the multiple optimal paths.

In step S4105, the coordinator node transmits a QRA command message including the timing information.

According to various embodiments of the present disclosure, the timing information may be generated based on buffer status information and QRA requirement information included in the QRA request message.

According to various embodiments of the present disclosure, the coordinator node may perform an optimal path search algorithm to generate information on the multiple optimal paths.

According to various embodiments of the present disclosure, the QRA command message may be transmitted to nodes related to the QRA.

According to various embodiments of the present disclosure, the nodes related to the QRA may be included in the multiple optimal paths.

According to various embodiments of the present disclosure, an entanglement distribution and an entanglement swapping related to the nodes related to the QRA may be performed based on the timing information.

According to various embodiments of the present disclosure, the QRA command message may be transmitted to the nodes related to the QRA through a dedicated channel.

According to various embodiments of the present disclosure, the embodiment of FIG. 41 may further include receiving a QRA report message as a result of performing the entanglement distribution and the entanglement swapping from one or more nodes to which the QRA command message is transmitted; determining a presence of a path among the multiple optimal paths on which a successful multi-hop entanglement swapping is performed based on the QRA report message; and transmitting a QRA complete message to the source node based on the presence of the path on which the successful multi-hop entanglement swapping is performed.

According to various embodiments of the present disclosure, there is provided a coordinator node in a communication system. The coordinator node includes a transceiver and at least one processor, and the at least one processor may be configured to perform an operation method of the coordinator node based on FIG. 41.

According to various embodiments of the present disclosure, there is provided a device controlling a coordinator node in a communication system. The device includes at least one processor and at least one memory operably connected to the at least one processor. The at least one memory may be configured to store instructions performing an operation method of the coordinator node based on FIG. 41 based on being executed by the at least one processor.

According to various embodiments of the present disclosure, there are provided one or more non-transitory computer readable mediums storing one or more instructions. The one or more instructions may be configured to perform operations based on being executed by one or more processors, and the operations may include an operation method of the coordinator node based on FIG. 41.

### Description of Claims Related to Coordinator Node (Distributed)

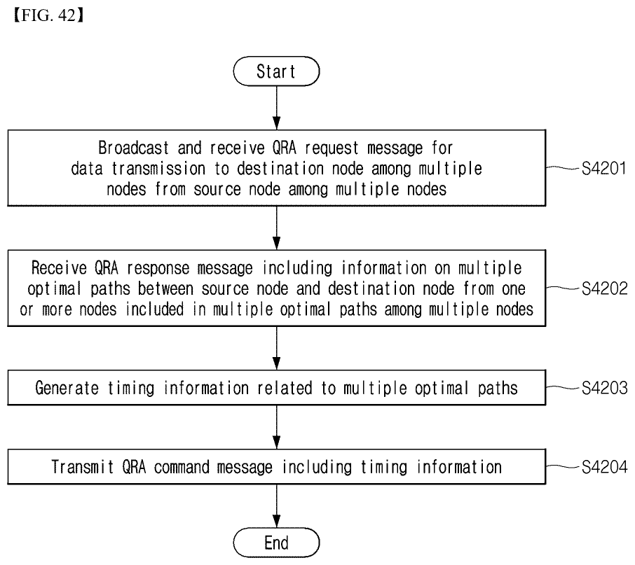

Below, the above-described embodiments are described in detail from an operation perspective for a coordinator node (distributed) with reference to FIG. 42. Methods to be described below are merely distinguished for convenience of explanation. Thus, as long as the methods are not mutually exclusive, it is obvious that partial configuration of any method can be substituted or combined with partial configuration of another method.

FIG. 42 illustrates an example of an operation process of a coordinator node (distributed) in a system applicable to the present disclosure.

According to various embodiments of the present disclosure, there is provided a method performed by a coordinator node in a communication system.

According to various embodiments of the present disclosure, each of multiple nodes including a source node and a destination node may correspond to one of a user equipment (UE) or a base station in a wireless communication system. According to various embodiments of the present disclosure, the coordinator node may correspond to one of a UE or a base station in the wireless communication system.

An embodiment of FIG. 42 may further include, before step S4201, a step in which the coordinator node transmits one or more synchronization signals to the multiple nodes; and a step in which the coordinator node transmits system information to the multiple nodes. The embodiment of FIG. 42 may further include, before the step S4201, a step in which the coordinator node receives a random access preamble from the multiple nodes; a step in which the coordinator node transmits a random access response (RAR) to the multiple nodes; a step in which the coordinator node receives a random access message 3 (message 3) from the multiple nodes; and a step in which the coordinator node transmits a contention resolution message to the multiple nodes. The message 3 is a first PUSCH transmission scheduled by a RAR together with an RAR UL grant.

The embodiment of FIG. 42 may further include, before the step S4201, a step in which the coordinator node transmits control information to the multiple nodes.

In the step S4201, the coordinator node broadcasts and receives, from a source node among the multiple nodes, a quantum resource allocation (QRA) request message for a data transmission to a destination node among the multiple nodes. The source node shares network topology information with remaining nodes among the multiple nodes. The network topology information includes information on an entanglement distribution success rate of multiple links related to the multiple nodes, and information on a Bell state measurement (BSM) success rate of the multiple nodes.

In step S4202, the coordinator node receives a QRA response message including information on multiple optimal paths between the source node and the destination node from one or more nodes included in the multiple optimal paths among the multiple nodes.

In step S4203, the coordinator node generates timing information related to the multiple optimal paths.

In step S4204, the coordinator node transmits a QRA command message including the timing information.

According to various embodiments of the present disclosure, the timing information may be generated based on buffer status information and QRA requirement information included in the QRA request message.

According to various embodiments of the present disclosure, one or more nodes included in the multiple optimal paths among the multiple nodes may perform an optimal path search algorithm to generate information on the multiple optimal paths.

According to various embodiments of the present disclosure, the QRA command message may be transmitted to nodes related to the QRA, and the nodes related to the QRA may be included in the multiple optimal paths.

According to various embodiments of the present disclosure, an entanglement distribution and an entanglement swapping related to the nodes related to the QRA may be performed based on the timing information.

According to various embodiments of the present disclosure, the QRA command message may be transmitted to the nodes related to the QRA in a broadcast manner.

According to various embodiments of the present disclosure, the embodiment of FIG. 42 may further include receiving a QRA complete message from the source node based on a presence of a path among the multiple optimal paths on which a successful multi-hop entanglement swapping is performed.

According to various embodiments of the present disclosure, there is provided a coordinator node in a communication system. The coordinator node includes a transceiver and at least one processor, and the at least one processor may be configured to perform an operation method of the coordinator node based on FIG. 42.

According to various embodiments of the present disclosure, there is provided a device controlling a coordinator node in a communication system. The device includes at least one processor and at least one memory operably connected to the at least one processor. The at least one memory may be configured to store instructions performing an operation method of the coordinator node based on FIG. 42 based on being executed by the at least one processor.

According to various embodiments of the present disclosure, there are provided one or more non-transitory computer readable mediums storing one or more instructions. The one or more instructions may be configured to perform operations based on being executed by one or more processors, and the operations may include an operation method of the coordinator node based on FIG. 42.

### Communication System Applicable to the Present Disclosure

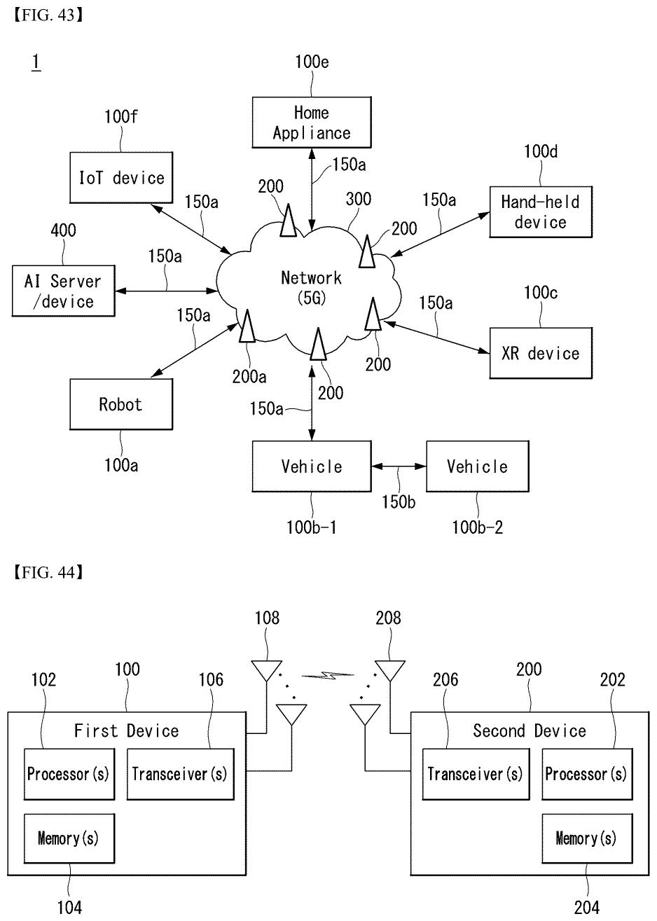

FIG. 43 illustrates a communication system 1 applied to various embodiments of the present disclosure.

Referring to FIG. 43, a communication system 1 applied to various embodiments of the present disclosure includes a wireless device, a base station, and a network. Herein, the wireless device refers to a device performing communication using Radio Access Technology (RAT) (e.g., 5G New RAT (NR)) or Long-Term Evolution (LTE), 6G wireless communication) and may be referred to as communication/radio/5G device/6G device. Although not limited thereto, the wireless devices may include a robot 100a, vehicles 100b-1 and 100b-2, an extended Reality (XR) device 100c, a hand-held device 100d, a home appliance 100e, an Internet of Things (IT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BS and the network may be implemented as wireless devices and a specific wireless device 200a may operate as a BS/network node with respect to other wireless devices.

The wireless devices 100a to 100f may be connected to the network 300 via the BS 200. An Artificial Intelligence (AI) technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network, or 6G network. Although the wireless devices 100a to 100f may communicate with each other through the BS 200/network 300, the wireless devices 100a to 100f may perform direct communication (e.g., sidelink communication) with each other without passing through the BS/network. For example, the vehicles 100b-1 and 100b-2 may perform direct communication (e.g. Vehicle-to-Vehicle (V2V)/Vehicle-to-everything (V2X) communication). Additionally, the IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BS/the wireless device, the base station and the base station may transmit/receive radio signals to/from each other through the wireless communication/connections 150a, 150b, and 150c. For example, the wireless communication/connections 150a, 150b, and 150c may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

NR supports multiple numerology (or subcarrier spacing (SCS)) to support various 5G services. For example, when SCS is 15 kHz, it supports a wide area in traditional cellular bands, and when SCS is 30 kHz/60 kHz, it supports dense-urban, lower latency, and wider carrier bandwidth, when SCS is 60 kHz or higher, it supports bandwidth greater than 24.25 GHz to overcome phase noise.

The NR frequency band can be defined as two types of frequency ranges (FR1, FR2). The values of the frequency range may be changed, for example, and the frequency ranges of the two types (FR1, FR2) may be as shown in Table 6 below. For convenience of explanation, among the frequency ranges used in the NR system, FR1 may mean “sub 6 GHz range”, and FR2 may mean “above 6 GHz range” and may be called millimeter wave (mmW).

TABLE 6

| Frequency | Corresponding | Subcarrier |
|---|---|---|
| Range Designation | Frequency Range | Spacing |
| FR1 | 450 MHz-6000 MHz | 15, 30, 60 kHz |
| FR2 | 24250 MHz-52600 MHz | 60, 120, 240 kHz |

As described above, the numerical value of the frequency range of the NR system can be changed. For example, FR1 may include a band of 410 MHz to 7125 MHz as shown in Table 7 below. That is, FR1 may include a frequency band of 6 GHz (or 5850, 5900, 5925 MHz, etc.). For example, the frequency band above 6 GHz (or 5850, 5900, 5925 MHz, etc.) included within FR1 may include an unlicensed band. Unlicensed bands can be used for a variety of purposes, for example, for communications for vehicles (e.g., autonomous driving).

TABLE 7

| Frequency | Corresponding | Subcarrier |
|---|---|---|
| Range Designation | Frequency Range | Spacing |
| FR1 | 41 MHz-7125 MHz | 15, 30, 60 kHz |
| FR2 | 24250 MHz-52600 MHz | 60, 120, 240 kHz |

According to various embodiments of the present disclosure, the communication system 1 may support terahertz (THz) wireless communication. THz wireless communication uses wireless communication using THz waves with a frequency of approximately 0.1 to 10 THz (1 THz=1012 Hz), and can refer to terahertz (THz) band wireless communication using a very high carrier frequency of 100 GHz or higher. The frequency band expected to be used for THz wireless communication may be the D-band (110 GHz to 170 GHz) or H-band (220 GHz to 325 GHz) bands, which have small propagation losses due to absorption of molecules in the air.

### Wireless Device Applicable to the Present Disclosure

Examples of a wireless device to which various embodiments of the present disclosure are applied are described below.

FIG. 44 illustrates a wireless device applicable to various embodiments of the present disclosure.

Referring to FIG. 44, a first wireless device 100 and a second wireless device 200 may transmit and receive radio signals through various wireless access technologies (e.g., LTE and NR). {The first wireless device 100 and the second wireless device 200} may correspond to {the wireless device 100x and the base station 200} and/or {the wireless device 100x and the wireless device 100x} of FIG. 43.

The first wireless device 100 may include one or more processors 102 and one or more memories 104 and may further include one or more transceivers 106 and/or one or more antennas 108. The processor 102 may control the memory 104 and/or the transceiver 106 and may be configured to implement the descriptions, functions, procedures, proposals, methods and/or operation flowcharts described in the present disclosure. For example, the processor 102 may process information within the memory 104 to generate first information/signal, and then transmit a radio signal including the first information/signal through the transceiver 106. Further, the processor 102 may receive a radio signal including second information/signal through the transceiver 106, and then store in the memory 104 information obtained from signal processing of the second information/signal. The memory 104 may be connected to the processor 102 and store various information related to an operation of the processor 102. For example, the memory 104 may store software codes including instructions for performing all or some of processes controlled by the processor 102 or performing the descriptions, functions, procedures, proposals, methods and/or operation flowcharts described in the present disclosure. The processor 102 and the memory 104 may be a part of a communication modem/circuit/chip designed to implement the wireless communication technology (e.g., LTE and NR). The transceiver 106 may be connected to the processor 102 and may transmit and/or receive the radio signals via one or more antennas 108. The transceiver 106 may include a transmitter and/or a receiver. The transceiver 106 may be used interchangeably with a radio frequency (RF) unit. In various embodiments of the present disclosure, the wireless device may mean the communication modem/circuit/chip.

The second wireless device 200 may include one or more processors 202 and one or more memories 204 and may further include one or more transceivers 206 and/or one or more antennas 208. The processor 202 may control the memory 204 and/or the transceiver 206 and may be configured to implement the descriptions, functions, procedures, proposals, methods and/or operation flowcharts described in the present disclosure. For example, the processor 202 may process information within the memory 204 to generate third information/signal and then transmit a radio signal including the third information/signal through the transceiver 206. Further, the processor 202 may receive a radio signal including fourth information/signal through the transceiver 206 and then store in the memory 204 information obtained from signal processing of the fourth information/signal. The memory 204 may be connected to the processor 202 and store various information related to an operation of the processor 202. For example, the memory 204 may store software codes including instructions for performing all or some of processes controlled by the processor 202 or performing the descriptions, functions, procedures, proposals, methods and/or operation flowcharts described in the present disclosure. The processor 202 and the memory 204 may be a part of a communication modem/circuit/chip designated to implement the wireless communication technology (e.g., LTE and NR). The transceiver 206 may be connected to the processor 202 and may transmit and/or receive the radio signals through one or more antennas 208. The transceiver 206 may include a transmitter and/or a receiver, and the transceiver 206 may be used interchangeably with the RF unit. In various embodiments of the present disclosure, the wireless device may mean the communication modem/circuit/chip.

Hardware elements of the wireless devices 100 and 200 are described in more detail below. Although not limited thereto, one or more protocol layers may be implemented by one or more processors 102 and 202. For example, one or more processors 102 and 202 may implement one or more layers (e.g., functional layers such as PHY, MAC, RLC, PDCP, RRC, and SDAP). One or more processors 102 and 202 may generate one or more protocol data units (PDUs) and/or one or more service data units (SDUs) based on the descriptions, functions, procedures, proposals, methods and/or operation flowcharts described in the present disclosure. One or more processors 102 and 202 may generate messages, control information, data, or information based on the descriptions, functions, procedures, proposals, methods and/or operation flowcharts described in the present disclosure. One or more processors 102 and 202 may generate a signal (e.g., a baseband signal) including the PDU, the SDU, the messages, the control information, the data, or the information based on the functions, procedures, proposals and/or methods described in the present disclosure, and provide the generated signal to one or more transceivers 106 and 206. One or more processors 102 and 202 may receive the signal (e.g., baseband signal) from one or more transceivers 106 and 206 and acquire the PDU, the SDU, the messages, the control information, the data, or the information based on the descriptions, functions, procedures, proposals, methods and/or operation flowcharts described in the present disclosure.

One or more processors 102 and 202 may be referred to as a controller, a microcontroller, a microprocessor, or a microcomputer. One or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in one or more processors 102 and 202. The descriptions, functions, procedures, proposals, methods and/or operation flowcharts described in the present disclosure may be implemented using firmware or software, and the firmware or software may be implemented to include modules, procedures, functions, and the like. Firmware or software configured to perform the descriptions, functions, procedures, proposals, methods and/or operation flowcharts described in the present disclosure may be included in one or more processors 102 and 202 or stored in one or more memories 104 and 204 and may be executed by one or more processors 102 and 202. The descriptions, functions, procedures, proposals, methods and/or operation flowcharts described in the present disclosure may be implemented using firmware or software in the form of codes, instructions and/or a set form of instructions.

The one or more memories 104 and 204 may be connected to the one or more processors 102 and 202 and store various types of data, signals, messages, information, programs, codes, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located inside and/or outside the one or more processors 102 and 202. The one or more memories 104 and 204 may be connected to the one or more processors 102 and 202 through various technologies such as wired or wireless connection.

The one or more transceivers 106 and 206 may transmit, to one or more other devices, user data, control information, radio signals/channels, etc. mentioned in the methods and/or operation flowcharts of the present disclosure. The one or more transceivers 106 and 206 may receive, from the one or more other devices, the user data, control information, radio signals/channels, etc. mentioned in the descriptions, functions, procedures, proposals, methods and/or operation flowcharts described in the present disclosure. For example, the one or more transceivers 106 and 206 may be connected to the one or more processors 102 and 202 and transmit and receive radio signals. For example, the one or more processors 102 and 202 may control the one or more transceivers 106 and 206 to transmit the user data, control information, or radio signals to the one or more other devices. The one or more processors 102 and 202 may control the one or more transceivers 106 and 206 to receive the user data, control information, or radio signals from the one or more other devices. The one or more transceivers 106 and 206 may be connected to the one or more antennas 108 and 208, and the one or more transceivers 106 and 206 may be configured to transmit and receive over the one or more antennas 108 and 208 the user data, control information, radio signals/channels, etc. mentioned in the descriptions, functions, procedures, proposals, methods and/or operation flowcharts described in the present disclosure. In the present disclosure, the one or more antennas may be a plurality of physical antennas or a plurality of logical antennas (e.g., antenna ports). The one or more transceivers 106 and 206 may convert the received radio signals/channels etc. from RF band signals to baseband signals in order to process the received user data, control information, radio signals/channels, etc. using the one or more processors 102 and 202. The one or more transceivers 106 and 206 may convert the user data, control information, radio signals/channels, etc. processed using the one or more processors 102 and 202 from the baseband signals to the RF band signals. To this end, the one or more transceivers 106 and 206 may include (analog) oscillators and/or filters.

FIG. 45 illustrates another example of a wireless device applicable to various embodiments of the present disclosure.

Referring to FIG. 45, a wireless device may include at least one processor 102 and 202, at least one memory 104 and 204, at least one transceiver 106 and 206, and one or more antennas 108 and 208.

The wireless device illustrated in FIG. 44 is different from the wireless device illustrated in FIG. 45 in that the processors 102 and 202 and the memories 104 and 204 are separated from each other in FIG. 44, and the processors 102 and 202 include the memories 104 and 204 in FIG. 45.

Since the detailed description for the processors 102 and 202, the memories 104 and 204, the transceivers 106 and 206, and the one or more antennas 108 and 208 is the same as that described above, repetitive descriptions are omitted to avoid unnecessary repetition of description.

Examples of a signal processing circuit to which various embodiments of the present disclosure are applied are described below.

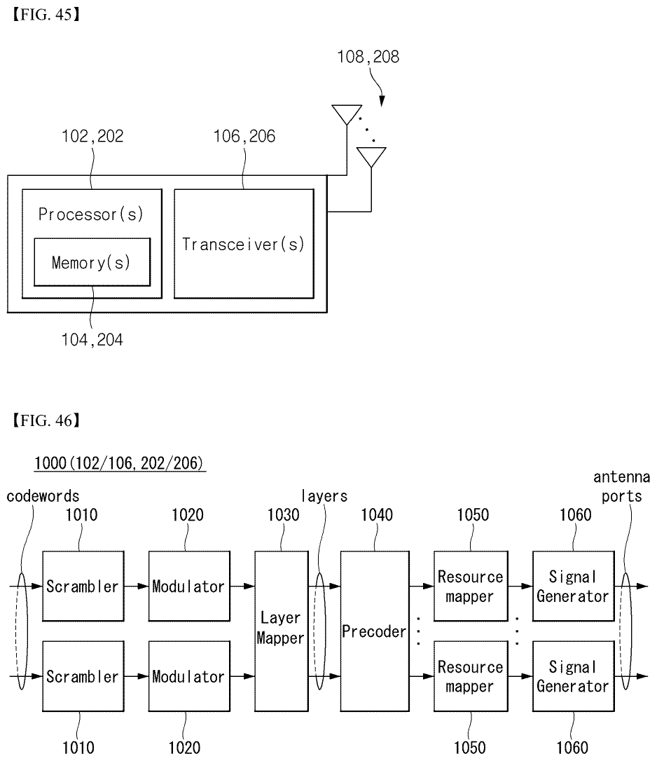

FIG. 46 illustrates a signal processing circuit for a transmission signal.

Referring to FIG. 46, a signal processing circuit 1000 may include scramblers 1010, modulators 1020, a layer mapper 1030, a precoder 1040, resource mappers 1050, and signal generators 1060. Although not limited to this, an operation/function of FIG. 46 may be performed by the processors 102 and 202 and/or the transceivers 106 and 206 of FIG. 44. Hardware elements of FIG. 46 may be implemented by the processors 102 and 202 and/or the transceivers 106 and 206 of FIG. 44. For example, blocks 1010 to 1060 may be implemented by the processors 102 and 202 of FIG. 44. Further, the blocks 1010 to 1050 may be implemented by the processors 102 and 202 of FIG. 44, and the block 1060 may be implemented by the transceivers 106 and 206 of FIG. 44.

Codewords may be converted into radio signals via the signal processing circuit 1000 of FIG. 46. The codewords are encoded bit sequences of information blocks. The information blocks may include transport blocks (e.g., a UL-SCH transport block, a DL-SCH transport block). The radio signals may be transmitted via various physical channels (e.g., PUSCH, PDSCH, etc.).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W, where N is the number of antenna ports, and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols, and the generated radio signals may be transmitted to other devices over each antenna. To this end, the signal generators 1060 may include inverse fast Fourier transform (IFFT) modules, cyclic prefix (CP) inserters, digital-to-analog converters (DACs), and frequency up-converters.

Signal processing procedures for a received signal in the wireless device may be configured in a reverse manner of the signal processing procedures 1010 to 1060 of FIG. 46. For example, the wireless devices (e.g., 100 and 200 of FIG. 44) may receive radio signals from the exterior through the antenna ports/transceivers. The received radio signals may be converted into baseband signals through signal restorers. To this end, the signal restorers may include frequency down-converters, analog-to-digital converters (ADCs), CP remover, and fast Fourier transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

Examples of use of a wireless device to which various embodiments of the present disclosure are applied are described below.

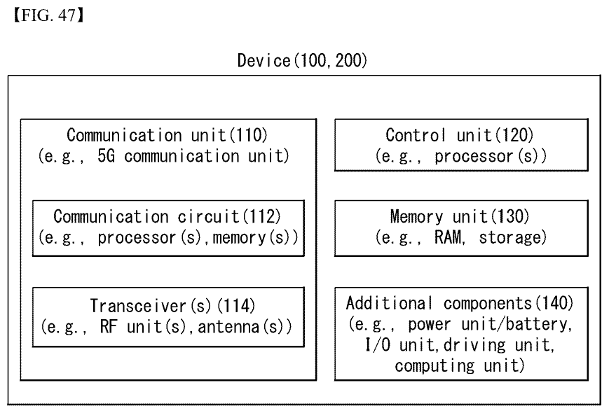

FIG. 47 illustrates another example of a wireless device applied to various embodiments of the present disclosure. The wireless device may be implemented in various forms based on use cases/services (see FIG. 43).

Referring to FIG. 47, wireless devices 100 and 200 may correspond to the wireless devices 100 and 200 of FIG. 44 and may consist of various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 44. For example, the transceiver(s) 114 may include the one or more transceivers 106 and 206 and/or the one or more antennas 108 and 208 of FIG. 44. The control unit 120 is electrically connected to the communication unit 110, the memory 130, and the additional components 140 and controls overall operation of the wireless devices. For example, the control unit 120 may control an electric/mechanical operation of the wireless device based on programs/codes/instructions/information stored in the memory unit 130. The control unit 120 may transmit the information stored in the memory unit 130 to the exterior (e.g., other communication devices) through the communication unit 110 via a wireless/wired interface or store, in the memory unit 130, information received via the wireless/wired interface from the exterior (e.g., other communication devices) through the communication unit 110.

The additional components 140 may be variously configured based on types of wireless devices. For example, the additional components 140 may include at least one of a power unit/battery, input/output (I/O) unit, a driving unit, and a computing unit. The wireless device may be implemented in the form of the robot (100a of FIG. 43), the vehicles (100b-1 and 100b-2 of FIG. 43), the XR device (100c of FIG. 35), the hand-held device (100d of FIG. 43), the home appliance (100e of FIG. 43), the IoT device (100f of FIG. 43), a digital broadcast terminal, a hologram device, a public safety device, an MTC device, a medicine device, a fintech device (or a finance device), a security device, a climate/environment device, the AI server/device (400 of FIG. 43), the BSs (200 of FIG. 43), a network node, etc., but is not limited thereto. The wireless device may be used in a mobile or fixed place based on a use-example/service.

In FIG. 47, all the various elements, components, units/parts, and/or modules of the wireless devices 100 and 200 may be connected to each other via wired interfaces or at least a part thereof may be wirelessly connected through the communication unit 110. For example, in each of the wireless devices 100 and 200, the control unit 120 and the communication unit 110 may be connected by wire, and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may consist of a set of one or more processors. As an example, the control unit 120 may include a set of a communication control processor, an application processor, an electronic control unit (ECU), a graphical processing unit, and a memory control processor. As another example, the memory 130 may include a random access memory (RAM), a dynamic RAM (DRAM), a read only memory (ROM)), a flash memory, a volatile memory, a non-volatile memory, and/or a combination thereof.

Examples of implementation of FIG. 47 are described in more detail below.

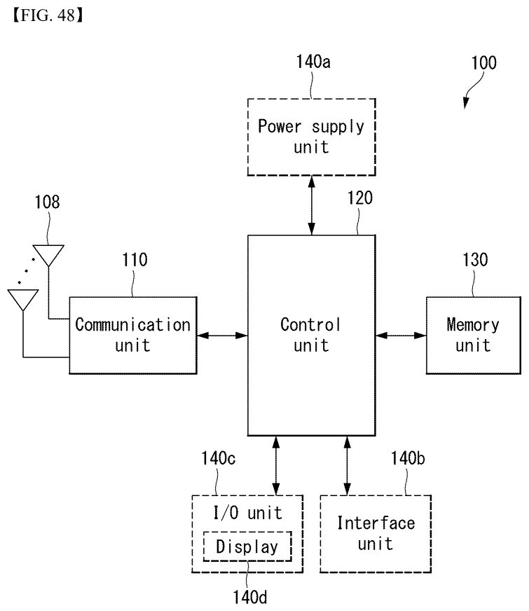

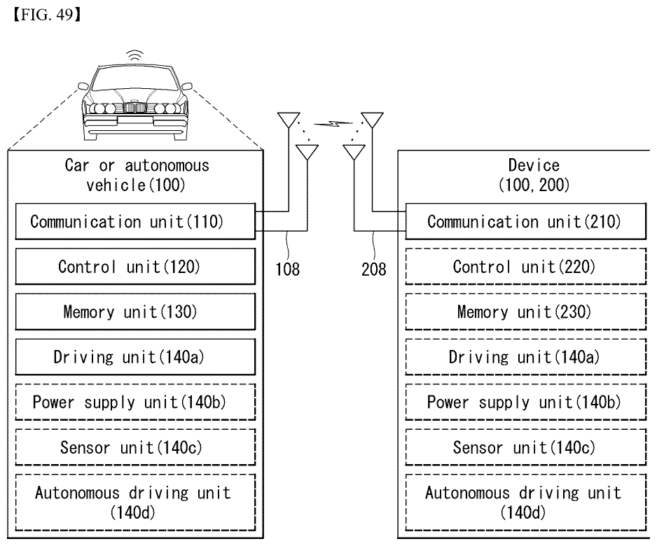

FIG. 48 illustrates a hand-held device applied to various embodiments of the present disclosure. The hand-held device may include a smartphone, a smartpad, a wearable device (e.g., a smartwatch or a smartglasses), or a portable computer (e.g., a notebook). The mobile device may be referred to as a mobile station (MS), a user terminal (UT), a mobile subscriber station (MSS), a subscriber station (SS), an advanced mobile station (AMS), or a wireless terminal (WT).

Referring to FIG. 48, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 47, respectively.

The communication unit 110 may transmit and receive signals (e.g., data and control signals) to and from other wireless devices or BSs. The control unit 120 may perform various operations by controlling components of the hand-held device 100. The control unit 120 may include an application processor (AP). The memory unit 130 may store data/parameters/programs/codes/instructions needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, for data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

FIG. 49 illustrates a vehicle or an autonomous vehicle applied to various embodiments of the present disclosure.

The vehicle or autonomous vehicle may be implemented by a mobile robot, a car, a train, a manned/unmanned Aerial Vehicle (AV), a ship, etc.

Referring to FIG. 49, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 47, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an electronic control unit (ECU). The driving unit 140a may allow the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a so that the vehicle or the autonomous vehicle 100 moves along the autonomous driving path based on the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transmit information on a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

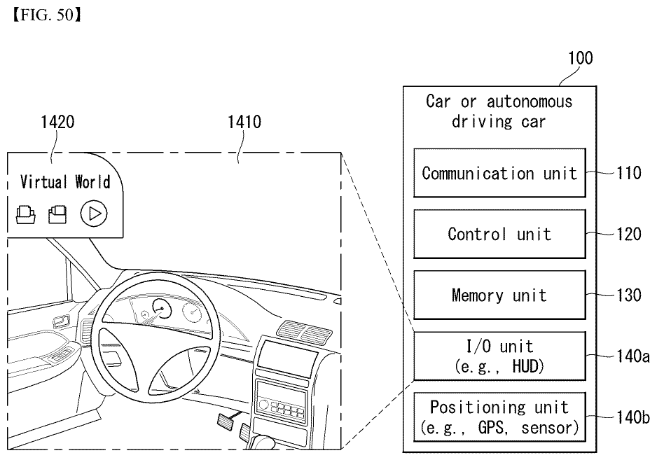

FIG. 50 illustrates a vehicle applied to various embodiments of the present disclosure. The vehicle may be implemented as a transport means, a train, an aerial vehicle, a ship, etc.

Referring to FIG. 50, a vehicle 100 may include a communication unit 110, a control unit 120, a memory unit 130, an I/O unit 140a, and a positioning unit 140b. The blocks 110 to 130/140a and 140b correspond to blocks 110 to 130/140 of FIG. 47, respectively.

The communication unit 110 may transmit and receive signals (e.g., data and control signals) to and from external devices such as other vehicles or base stations. The control unit 120 may perform various operations by controlling components of the vehicle 100. The memory unit 130 may store data/parameters/programs/codes/instructions for supporting various functions of the vehicle 100. The I/O unit 140a may output an AR/VR object based on information within the memory unit 130. The I/O unit 140a may include an HUD. The positioning unit 140b may acquire location information of the vehicle 100. The location information may include absolute location information of the vehicle 100, location information of the vehicle 100 within a traveling lane, acceleration information, and location information of the vehicle 100 from a neighboring vehicle. The positioning unit 140b may include a GPS and various sensors.

As an example, the communication unit 110 of the vehicle 100 may receive map information and traffic information from an external server and store the received information in the memory unit 130. The positioning unit 140b may obtain vehicle location information through the GPS and the various sensors and store the obtained information in the memory unit 130. The control unit 120 may generate a virtual object based on the map information, the traffic information, and the vehicle location information, and the I/O unit 140a may display the generated virtual object on a window in the vehicle (1410 and 1420). The control unit 120 may determine whether the vehicle 100 normally drives within a traveling lane, based on the vehicle location information. If the vehicle 100 abnormally exits from the traveling lane, the control unit 120 may display a warning on the window in the vehicle through the I/O unit 140a. In addition, the control unit 120 may broadcast a warning message about driving abnormity to neighboring vehicles through the communication unit 110. According to situations, the control unit 120 may transmit the location information of the vehicle and the information about driving/vehicle abnormality to related organizations through the communication unit 110.

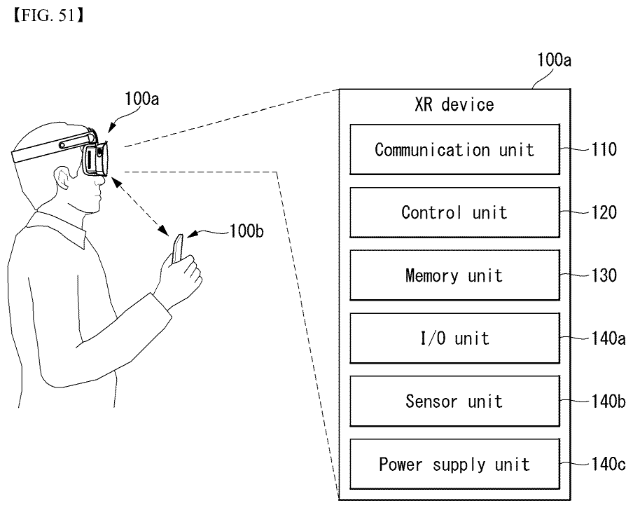

FIG. 51 illustrates an XR device applied to various embodiments of the present disclosure. The XR device may be implemented as an HMD, a head-up display (HUD) mounted in a vehicle, a television, a smartphone, a computer, a wearable device, a home appliance, a digital signage, a vehicle, a robot, etc.

Referring to FIG. 51, an XR device 100a may include a communication unit 110, a control unit 120, a memory unit 130, an I/O unit 140a, a sensor unit 140b, and a power supply unit 140c. The blocks 110 to 130/140a to 140c correspond to the blocks 110 to 130/140 of FIG. 47, respectively.

The communication unit 110 may transmit and receive signals (e.g., media data, control signal, etc.) to and from external devices such as other wireless devices, handheld devices, or media servers. The media data may include video, images, sound, etc. The control unit 120 may control components of the XR device 100a to perform various operations. For example, the control unit 120 may be configured to control and/or perform procedures such as video/image acquisition, (video/image) encoding, and metadata generation and processing. The memory unit 120 may store data/parameters/programs/codes/instructions required to drive the XR device 100a/generate an XR object. The I/O unit 140a may obtain control information, data, etc. from the outside and output the generated XR object. The I/O unit 140a may include a camera, a microphone, a user input unit, a display, a speaker, and/or a haptic module. The sensor unit 140b may obtain a state, surrounding environment information, user information, etc. of the XR device 100a. The sensor 140b may include a proximity sensor, an illumination sensor, an acceleration sensor, a magnetic sensor, a gyro sensor, an inertial sensor, an RGB sensor, an IR sensor, a fingerprint scan sensor, an ultrasonic sensor, a light sensor, a microphone, and/or a radar. The power supply unit 140c may supply power to the XR device 100a and include a wired/wireless charging circuit, a battery, etc.

For example, the memory unit 130 of the XR device 100a may include information (e.g., data) required to generate the XR object (e.g., an AR/VR/MR object). The I/O unit 140a may obtain instructions for manipulating the XR device 100a from a user, and the control unit 120 may drive the XR device 100a based on a driving instruction of the user. For example, if the user desires to watch a film, news, etc. through the XR device 100a, the control unit 120 may transmit content request information to another device (e.g., a handheld device 100b) or a media server through the communication unit 110. The communication unit 110 may download/stream content such as films and news from another device (e.g., the handheld device 100b) or the media server to the memory unit 130. The control unit 120 may control and/or perform procedures, such as video/image acquisition, (video/image) encoding, and metadata generation/processing, for the content and generate/output the XR object based on information about a surrounding space or a real object obtained through the I/O unit 140a/sensor unit 140b.

The XR device 100a may be wirelessly connected to the handheld device 100b through the communication unit 110, and the operation of the XR device 100a may be controlled by the handheld device 100b. For example, the handheld device 100b may operate as a controller of the XR device 100a. To this end, the XR device 100a may obtain 3D location information of the handheld device 100b and generate and output an XR object corresponding to the handheld device 100b.

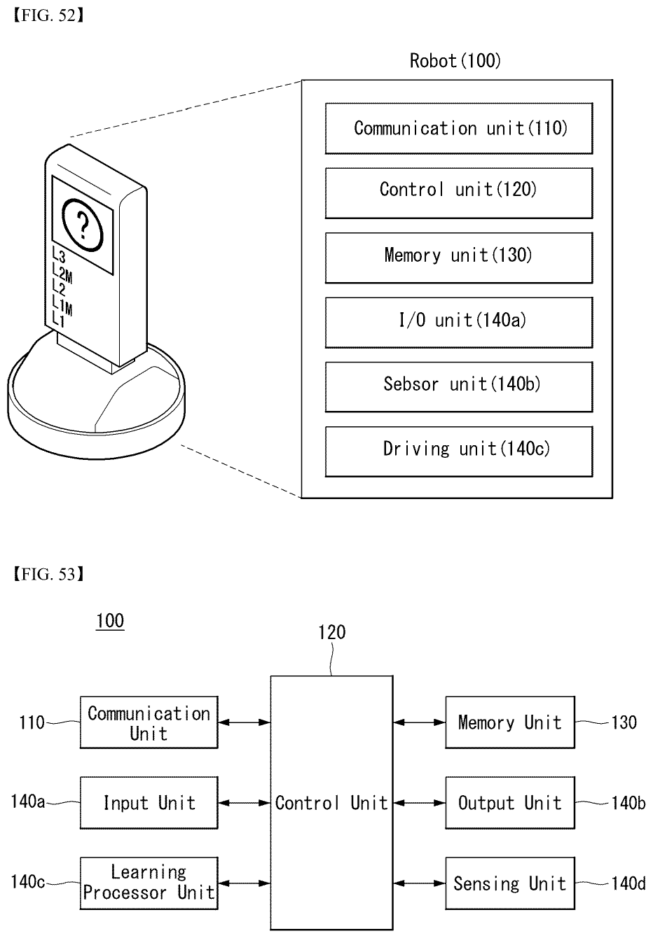

FIG. 52 illustrates a robot applied to various embodiments of the present disclosure. The robot may be categorized into an industrial robot, a medical robot, a household robot, a military robot, etc., based on a used purpose or field.

Referring to FIG. 52, a robot 100 may include a communication unit 110, a control unit 120, a memory unit 130, an I/O unit 140a, a sensor unit 140b, and a power supply unit 140c. The blocks 110 to 130/140a to 140c correspond to the blocks 110 to 130/140 of FIG. 47, respectively.

The communication unit 110 may transmit and receive signals (e.g., driving information and control signals) to and from external devices such as other wireless devices, other robots, or control servers. The control unit 120 may perform various operations by controlling components of the robot 100. The memory unit 130 may store data/parameters/programs/codes/instructions for supporting various functions of the robot 100. The I/O unit 140a may obtain information from the outside of the robot 100 and output information to the outside of the robot 100. The I/O unit 140a may include a camera, a microphone, a user input unit, a display unit, a speaker, and/or a haptic module. The sensor unit 140b may obtain internal information of the robot 100, surrounding environment information, user information, etc. The sensor unit 140b may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit 140c may perform various physical operations such as movement of robot joints. In addition, the driving unit 140c may allow the robot 100 to travel on the road or to fly. The driving unit 140c may include an actuator, a motor, a wheel, a brake, a propeller, etc.

FIG. 53 illustrates an AI device applied to various embodiments of the present disclosure.

The AI device may be implemented as a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 53, an AI device 100 may include a communication unit 110, a control unit 120, a memory unit 130, an input unit 140a, an out unit 140b, a learning processor unit 140c, and a sensor unit 140d. The blocks 110 to 130/140a to 140d correspond to the blocks 110 to 130/140 of FIG. 47, respectively.

The communication unit 110 may transmit and receive wired/radio signals (e.g., sensor information, user input, learning models, or control signals) to and from external devices such as other AI devices (e.g., 100x, 200, or 400 of FIG. 43) or an AI server 200 using wired/wireless communication technology. To this end, the communication unit 110 may transmit information within the memory unit 130 to an external device and transmit a signal received from the external device to the memory unit 130.

The control unit 120 may determine at least one feasible operation of the AI device 100, based on information which is determined or generated using a data analysis algorithm or a machine learning algorithm. The control unit 120 may perform an operation determined by controlling components of the AI device 100. For example, the control unit 120 may request, search, receive, or use data of the learning processor unit 140c or the memory unit 130 and control the components of the AI device 100 to perform a predicted operation or an operation determined to be preferred among at least one feasible operation. The control unit 120 may collect history information including the operation contents of the AI device 100 and operation feedback by a user and store the collected information in the memory unit 130 or the learning processor unit 140c or transmit the collected information to an external device such as an AI server (400 of FIG. 43). The collected history information may be used to update a learning model.

The memory unit 130 may store data for supporting various functions of the AI device 100. For example, the memory unit 130 may store data obtained from the input unit 140a, data obtained from the communication unit 110, output data of the learning processor unit 140c, and data obtained from the sensor unit 140. The memory unit 130 may store control information and/or software code needed to operate/drive the control unit 120.

The input unit 140a may acquire various types of data from the exterior of the AI device 100. For example, the input unit 140a may acquire learning data for model learning, and input data to which the learning model is to be applied. The input unit 140a may include a camera, a microphone, and/or a user input unit. The output unit 140b may generate output related to a visual, auditory, or tactile sense. The output unit 140b may include a display unit, a speaker, and/or a haptic module. The sensing unit 140 may obtain at least one of internal information of the AI device 100, surrounding environment information of the AI device 100, and user information, using various sensors. The sensor unit 140 may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit 140c may learn a model consisting of artificial neural networks, using learning data. The learning processor unit 140c may perform AI processing together with the learning processor unit of the AI server (400 of FIG. 43). The learning processor unit 140c may process information received from an external device through the communication unit 110 and/or information stored in the memory unit 130. In addition, an output value of the learning processor unit 140c may be transmitted to the external device through the communication unit 110 and may be stored in the memory unit 130.

The claims described in various embodiments of the present disclosure can be combined in various ways. For example, technical features of the method claims of various embodiments of the present disclosure can be combined and implemented as a device, and technical features of the device claims of various embodiments of the present disclosure can be combined and implemented as a method. In addition, the technical features of the method claims and the technical features of the device claims in various embodiments of the present disclosure can be combined and implemented as a device, and the technical features of the method claims and the technical features of the device claims in various embodiments of the present disclosure can be combined and implemented as a method.

1. A method of operating a third node in a communication system, the method comprising:
transmitting one or more synchronization signals to multiple nodes;
transmitting system information to the multiple nodes;
receiving a random access preamble from the multiple nodes;
transmitting a random access response to the multiple nodes;
receiving network topology information from the multiple nodes, the network topology information including information on an entanglement distribution success rate of multiple links related to the multiple nodes, and information on a bell state measurement (BSM) success rate of the multiple nodes;
receiving, from a first node among the multiple nodes, a quantum resource allocation (QRA) request message for a data transmission to a second node among the multiple nodes;
acquiring information on multiple optimal paths between the first node and the second node, the multiple optimal paths being determined based on the network topology information;
generating timing information related to the multiple optimal paths; and
transmitting a QRA command message including the timing information.

2. The method of claim 1, wherein the timing information is generated based on buffer status information and QRA requirement information included in the QRA request message.

3. The method of claim 1, wherein the third node performs an optimal path search algorithm to generate the information on the multiple optimal paths.

4. The method of claim 1, wherein the QRA command message is transmitted to nodes related to the QRA, and
wherein the nodes related to the QRA are included in the multiple optimal paths.

5. The method of claim 4, wherein an entanglement distribution and an entanglement swapping related to the nodes related to the QRA are performed based on the timing information.

6. The method of claim 4, wherein the QRA command message is transmitted to the nodes related to the QRA through a dedicated channel.

7. The method of claim 5, further comprising:
receiving a QRA report message, as a result of performing the entanglement distribution and the entanglement swapping, from one or more nodes to which the QRA command message is transmitted;
determining a presence of a path among the multiple optimal paths on which a successful multi-hop entanglement swapping is performed based on the QRA report message; and
transmitting a QRA complete message to the first node based on the presence of the path on which the successful multi-hop entanglement swapping is performed.

8. A method of operating a third node in a communication system, the method comprising:
transmitting one or more synchronization signals to multiple nodes;
transmitting system information to the multiple nodes;
receiving a random access preamble from the multiple nodes;
transmitting a random access response to the multiple nodes;
broadcasting and receiving, from a first node among the multiple nodes, a quantum resource allocation (QRA) request message for a data transmission to a second node among the multiple nodes, wherein the first node shares network topology information with remaining nodes among the multiple nodes, and the network topology information includes information on an entanglement distribution success rate of multiple links related to the multiple nodes, and information on a bell state measurement (BSM) success rate of the multiple nodes;
receiving a QRA response message including information on multiple optimal paths between the first node and the second node from one or more nodes included in the multiple optimal paths among the multiple nodes;
generating timing information related to the multiple optimal paths; and
transmitting a QRA command message including the timing information.

9. The method of claim 8, wherein the timing information is generated based on buffer status information and QRA requirement information included in the QRA request message.

10. The method of claim 8, wherein the one or more nodes included in the multiple optimal paths among the multiple nodes perform an optimal path search algorithm to generate the information on the multiple optimal paths.

11. The method of claim 8, wherein the QRA command message is transmitted to nodes related to the QRA, and
wherein the nodes related to the QRA are included in the multiple optimal paths.

12. The method of claim 11, wherein an entanglement distribution and an entanglement swapping related to the nodes related to the QRA are performed based on the timing information.

13. The method of claim 11, wherein the QRA command message is transmitted to the nodes related to the QRA in a broadcast manner.

14. The method of claim 12, further comprising:
receiving a QRA complete message from the first node based on a presence of a path among the multiple optimal paths on which a successful multi-hop entanglement swapping is performed.

15. A third node in a communication system, the third node comprising:
a transceiver; and
at least one processor,
wherein the at least one processor is configured to:
transmit one or more synchronization signals to multiple nodes;
transmit system information to the multiple nodes;
receive a random access preamble from the multiple nodes;
transmit a random access response to the multiple nodes;
receive network topology information from the multiple nodes, the network topology information including information on an entanglement distribution success rate of multiple links related to the multiple nodes, and information on a bell state measurement (BSM) success rate of the multiple nodes;
receive, from a first node among the multiple nodes, a quantum resource allocation (QRA) request message for a data transmission to a second node among the multiple nodes;
acquire information on multiple optimal paths between the first node and the second node, the multiple optimal paths being determined based on the network topology information;
generate timing information related to the multiple optimal paths; and
transmit a QRA command message including the timing information.

16-20. (canceled)
